(19) United States
(12) Patent Application Publication
(10) Pub. No.: US 2008/0091463 A1
(43) Pub. Date: Apr. 17, 2008

(54) Method for online health management

(76) Inventor: Ravi Shakamuri, Odessa, TX (US)

Correspondence Address: David G. Moore;Strasburger & Price, LLP, Suite 4400, 901 Main St., Dallas, TX, 75202, US

(21) Appl. No.: 11/823,137

(22) Filed: Jun. 27, 2007

Related U.S. Application Data
(60) Provisional application No. 60/817,233, filed on Jun. 28, 2006.

(51) Int. Cl. G06Q 50/00; G06Q 30/00

(52) U.S. Cl. 705/2; 705/32; 705/35

(57) ABSTRACT

The invention disclosed herein is a method for online health management. The method is family centered with the family, the family's health care providers, and family's health insurance entities linked by computer for the sharing of information. The medical information stored in the online health management system database is available to authorized persons anytime, anywhere. Additionally, the online health management system evaluates the family health insurance and advises the family of the schedule of benefits available to them. In this way the family may use all of their benefits to promote good health rather than using the health benefits solely for the purpose of paying for treatment of medical problems when such exist. The online health management system periodically measures and tracks certain vital signs and then compares those vital signs to published standards of normality. The vital signs are averaged together and a health score is generated which advises the family and health care providers of risks to the patients health. The family can then institute treatment plans in conjunction with their health care providers to lessen the risks to their health. Improvement in the health score can be used as feedback to the family and health care provider that the treatment plan is effective.

### CROSS-REFERENCE TO RELATED APPLICATIONS

This patent application claims the benefit of and priority to U.S. Provisional Patent Application No. 60/817,233 filed on Jun. 28, 2006 which is incorporated herein by reference as if fully set forth.

### STATEMENT REGARDING FEDERALLY SPONSORED RESEARCH OR DEVELOPMENT

The invention disclosed herein was not the subject of federally sponsored research or development.

### BACKGROUND

1. Field

The invention disclosed in the instant application is a method linking, by computer, all participants in the provision, receipt, reimbursement and decision-making roles in health care in an Online Health Management System.

2. Description of the Related Art

The provision of medical and health care to a patient requires the interaction of many different types of participants. In today's method of healthcare provision the physician is at the center of the process. The attending physician may be a generalist, commonly known as a family practitioner who engages specialist physicians to participate in the patients care depending on the nature of the patient's medical problem.

Assisting the physicians in the provision of health care to a patient is a kaleidoscope of other health care providers. Among those healthcare providers are: nurses, radiologic technicians, respiratory technologists, laboratorians, physical therapists, pharmacists, nurses aids, surgical technicians, phlebotomists, and others.

Another layer of participants in the provision of health care providers are the record keepers. Those record keepers include medical record technicians, ward clerks, secretaries, computer specialists and file clerks.

The next layer of participants would be the managers of those who participate directly in the provision of health care. Those include hospital administrators, directors of nursing, chief financial officers, chief medical officers, directors of compliance, quality assurance managers and the like.

The next layer present in the provision of health care includes those individuals involved in providing payment to the health care providers for the provision of medical and health care. That group includes entities such as insurance companies, preferred provider organizations, health maintenance organizations, self-insured parties and governmental entities such as Medicare, Medicaid, Aid for Dependent Children and others.

Most all of the people involved in the provision of health care generate information which must be systematically maintained and available to all of the participants. The types of information which must be systematically maintained and available include: doctor's orders and progress notes, vital signs, laboratory reports, radiology films and reports, nurse's notes and assessments, operative notes, consents and authorizations, reimbursement data, etc.

Organizing this data is in some measure dependent on the facility in which health care is provided. At one end of the spectrum where organization of medical information is highly ordered and regulated, is a hospital. At the other end of the spectrum would be an entity such as home health nursing, where the information generated is not continual and may be kept informally.

There have been various attempts at organizing medical data so that it is readily accessible to the healthcare providers. In a patent issued to Khorasani et al. (U.S. Pat. No. 6,029,138), a decision support system is disclosed in which a physician's practice of ordering diagnostic or therapeutic tests or interventions is monitored so that the physician receives feedback and information for intelligent and relevant decision-making.

An Online Health Management System is disclosed in a patent to Mcllroy et al. (U.S. Pat. No. 5,583,758). In this disclosure, data relating to the patients medical condition and treatments is kept. Information regarding treatment options is provided by the system.

A patient satisfaction survey is disclosed in a patent to Kraftson et al. (U.S. Pat. No. 6,151,581). Data is collected from surveys completed by the healthcare providers and patients as to the satisfaction of the patient and healthcare provider with the healthcare experience. The data is organized in order to advise the healthcare providers as to ways to improve the healthcare delivery process.

Recommended treatment options based on the patients clinical conditions is disclosed in another patent to Mcllroy et al. (U.S. Pat. No. 5,5953,704). The data collected is used to suggest alternative therapies or provide explanatory information as to reasons why the final treatment recommendations differed from the guideline treatment options.

It is in the best interest of the patient that all of the information concerning a patient be available to all providers who need that information. It is also in the best interest of the patient that all who participate in the provision of health care be able to communicate with each other and the patient so that health care can be provided as efficiently and safely as possible. The current system of health care is centered about the primary physician and not the patient and in that system the patient is often left out of the decision making process.

It is undisputed that there is a health care reimbursement crisis in this country. While many individuals and families have some form of health insurance, many of the benefits provided by the health insurance provider are going unused. Insurance benefits which could be used to promote health are instead being used to treat medical problems after the problem develops. Treatment of a medical problem after it has developed is much more expensive that preventing the medical problem from developing in the first place. There is no established method in which the schedule of available health insurance benefits are analyzed and communicated to the family so that benefits can be timely used and not wasted by failing to take advantage of such benefits. Further, there is no convenient method by which the overall health of an individual or family can be monitored on a continual basis. There is also a need for a method to send feedback on the effectiveness of medical treatment to the health care providers, patient and family members. The provision of feed back would enable the health care team and family to measure whether a particular treatment plan was effective or not. None of the prior art satisfies these needs. There is a need in the art for a patient-centered method for Online Health Management which accomplishes the goal of systematically organizing medical information, analyzes available sources for payment of health-related expenses and communicates those benefits to the family so that said benefits can be used, advises the family as to their general health needs, enables communication between participants, provides feedback to the providers, patient and family, and monitors the expenses and payments related to health care.

### BRIEF SUMMARY OF THE INVENTION

The invention disclosed herein is a method which accomplishes the goal of systematically organizing medical information, analyzes available sources for payment of medical expenses, communicates those benefits to the family so that said benefits can be used, advises the family as to their general health needs, enables communication between participants, provides feedback to the providers and family and monitors the expenses and payments related to health care. The methods of the invention disclosed herein are family-centered. The family has ready access to all information needed to assist them in the decision-making process. No longer is the family dependent on receiving information regarding their health care from a health care provider. Information regarding their health status is available anytime, anywhere. Family members are connected by computer to the Online Health Management System. Initially, details regarding individual and family medical history are input into the system. Based on the individual's medical history and current vital signs and medical needs, the system and method tracks the specific treatment requirements of each individual of the family. With ongoing periodic monitoring of vital signs and other parameters, abnormalities in physical health can be identified and referral to the appropriate health care provider arranged. The Online Health Management System disclosed herein can provide: 1) physician appointment reminders by phone or email, 2) medication reminders by phone or email, 3) analysis of insurance coverage plans to direct the family to appropriate care to maximize benefits, 4) referral to community sources, such as nutrition centers, diet centers, gyms or medical providers to address current medical needs, 5) provide follow-up to the patient and medical providers to establish effectiveness of medical services to the individual, and 6) participate in wellness programs based on individual clinical benchmarks.

In order to accomplish the above goals, each member of the family is provided a two-digit score which is based on the individual and family medical history, measurement of certain vital signs and comparison of those vital signs with published norms. Based on a scale of 1-100 with 100 representing an extreme risk of development of disease and 1 representing minimal risk of disease development, the individual can instantly assess his or her health needs based on their score. Armed with the knowledge of their relative health score, the individual can make an informed decision regarding his personal health needs. Since the aforementioned health score is updated by periodic measurement of vital signs, the patient and relevant health care providers can obtain a measure of the effectiveness of the treatment plan.

The method for Online Health Management disclosed herein also links, by computer, all of the family members to each person's medical providers, auxiliary health care providers and those responsible for payment of health services. By including all of the participants in the health care network, treatments ordered by different health care providers are not duplicated, health care of minors or the elderly can be monitored by the family and the health care team and needless expenditure of scarce medical resources can be prevented.

### BRIEF DESCRIPTION OF THE DRAWING/FIGURES

A better understanding of the Online Health Management System disclosed herein may be had by review of the following drawing figures:

FIG. 1 is a diagram of the current prior art Provider centric Healthcare Model.

FIG. 2 is a diagram showing the Family Centric Healthcare model disclosed in the instant application.

FIG. 3 is a diagram of the Family centric healthcare model showing the family-insurance benefit segmentation relationship.

FIGS. 4, 4A, 4B and 4C are a diagram of the process flow describing the home health referral system of the Online Health Management System.

FIG. 5 is a flow diagram showing the development of the individual and family health score.

FIG. 6 is an exemplary computer screen showing the myscore home page.

FIG. 7 is an exemplary computer screen showing the myscore workspace screen.

FIG. 8 is an exemplary interactive computer screen showing member personal detail information.

FIG. 9 is an exemplary interactive computer screen showing an individual health record.

FIG. 10 is an exemplary interactive computer screen showing member provider details.

FIG. 11 is an exemplary interactive computer screen showing member insurance details.

FIG. 12 is an exemplary interactive computer screen showing member medications.

FIG. 13 is an exemplary interactive computer screen showing member allergies.

FIG. 14 is an exemplary interactive computer screen showing an individual's immunizations.

FIG. 15 is an exemplary interactive computer screen showing an individual's surgeries.

FIG. 16 is an exemplary interactive computer screen showing an individual's health history.

FIG. 17 is an exemplary interactive computer screen showing a monthly health appointment calendar.

FIG. 18 is an exemplary interactive computer screen showing a weekly health appointment calendar.

FIG. 19 is an exemplary interactive computer screen showing a daily health appointment calendar.

FIG. 20 is an exemplary interactive computer screen showing the addition of a new event on the health calendar.

FIG. 21 is an exemplary interactive computer screen showing the child's health record introductory page.

FIG. 22 is an exemplary interactive computer screen showing a child's vaccination schedule.

FIG. 23 is an exemplary interactive computer screen showing a record of a child's height over a period of time.

FIG. 24 is an exemplary interactive computer screen showing how a new height measurement is recorded.

FIG. 25 is an exemplary interactive computer screen comparing a child's height to published norms.

FIG. 26 is an exemplary interactive computer screen showing a record of a child's weight over a period of time.

FIG. 27 is an exemplary interactive computer screen showing how a new weight measurement is recorded.

FIG. 28 is an exemplary interactive computer screen comparing a child's weight to published norms.

FIG. 29 is an exemplary computer screen showing a graph comparing the child's body mass index to published norms.

FIG. 30 is an exemplary interactive computer screen showing how a new member is registered into the system.

FIG. 31 is an exemplary interactive computer screen showing how an individuals basic information is recorded.

FIG. 32 is an exemplary computer screen showing when the system is accessed.

FIG. 33 is an exemplary interactive computer screen showing an individual's contact information.

FIG. 34 is an exemplary interactive computer screen showing the family members who are registered in the system.

FIG. 35 is an exemplary computer screen showing in graphic form the family health tracker for blood pressure measurements.

FIG. 36 is an exemplary interactive computer screen showing the method for recording basic personal information in the system.

FIG. 37 is an exemplary interactive computer screen showing the entry form for health assessment health habits.

FIG. 38 is an exemplary interactive computer screen for recording an individual's past medical history.

FIG. 39 is an exemplary interactive computer screen for recording current clinical symptoms.

FIG. 40 is an exemplary computer screen displaying an individual's health score.

FIG. 41 is an exemplary interactive computer screen displaying in graphic form an individual's blood pressure recordings.

FIG. 42 is an exemplary interactive computer screen for editing blood pressure recordings.

FIG. 43 is an exemplary interactive computer screen for adding blood pressure recordings.

FIG. 44 is an exemplary interactive computer screen for display of blood sugar data in graphic form.

FIG. 45 is an exemplary interactive computer screen for display of blood sugar data in tabular form.

FIG. 46 is an exemplary interactive computer screen for entry of blood sugar measurements.

FIG. 47 is an exemplary interactive computer screen for display of cholesterol values in graphic form.

FIG. 48 is an exemplary interactive computer screen for display of cholesterol values in tabular form.

FIG. 49 is an exemplary interactive computer screen for entry of cholesterol measurements.

FIG. 50 is an exemplary interactive computer screen for display of an individual's weight in graphic form over a period of time.

FIG. 51 is an exemplary interactive computer screen for display of an individual's weight in tabular form.

FIG. 52 is an exemplary interactive computer screen for entry of an individual's body weight measurements.

FIG. 53 is an exemplary interactive computer screen for display of an individual's triglyceride level.

FIG. 54 is an exemplary interactive computer screen for display of an individual's triglyceride levels in tabular form.

FIG. 55 is an exemplary interactive computer screen for entry of triglyceride measurements.

### DETAILED DESCRIPTION OF THE INVENTION

As mentioned above the delivery of health care to a patient involves the participation of many different types of care providers, the patient and their families as well as the entity which ultimately provides payment for the health services. The invention disclosed in the instant application is a method by which all persons and entities involved in the delivery, receipt or payment of health care can be seamlessly integrated so as to provide a mechanism for the efficient and effective delivery of health care to the patient. Further, the Online Health Management System disclosed herein provides a method for tracking certain personal vital signs to generate a health score reflecting the overall risk of disease development. By using the concept of a family “healthwatcher”, the family's general health can be periodically evaluated and medical or other intervention instituted as appropriate. The method disclosed in the instant application uses a secure and encrypted computer module which enables providers and support staff to share information electronically and remain compliant with applicable state and federal privacy laws and regulations.

The Online Health Management System disclosed herein is also a method which promotes the development and preservation of optimum health. The Online Health Management System accomplishes this task by linking together, through computer, the family and the family's healthcare providers. All of the medical records relating to the family and prepared by the healthcare providers are digitally transferred to the Online Health Management System where anyone, with proper authorization from the family, can examine the family medical records. Further, the Online Health Management System tracks certain vital signs, whose measurement is obtained from the family or the family healthcare provider and is organized so as to advise the family of potential risks to their health. Central to the Online Health Management System is the family “healthwatcher”. The family “healthwatcher” is that family member designated by the family to periodically monitor the vital sign tracking function provided by the Online Health Management System. The healthwatcher is usually the person who would be most likely to be motivated to follow the health tracking information, keep track of health-related appointments and encourage other family members to take steps to improve their overall health. The entry of data by either the healthwatcher, healthcare provider or other individual into the Online Health Management System as well as display of collated data, preparation of summaries, analysis of vital signs transmission of alerts, maintenance of appointments on a calendar and other functions are accomplished by and through computers in a manner well-known to those of ordinary skill in the art.

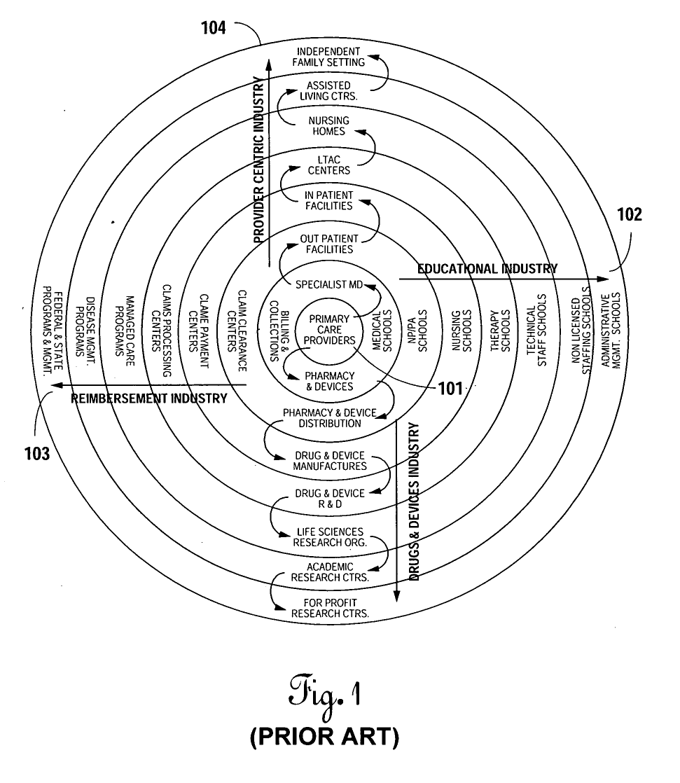

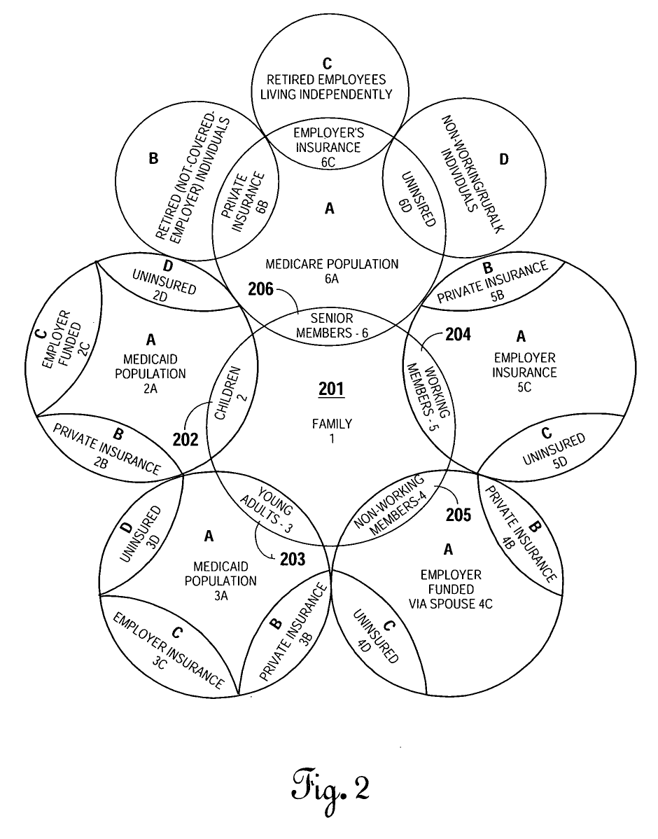

As shown in FIG. 1, the current health care model is centered around the primary care providers 101. Those primary care providers include physicians, nurses, hospitals, clinics and others providing direct care to the individual patient. The health care educational system 102 is directed toward the training of primary care providers and others ancillary to the health care process. Any health education that comes the way of the patient or their family is usually at the discretion of the primary physician or other health provider 101. The reimbursement process 103 is directed toward paying bills related to treatment which is usually initiated at the primary health care provider level. Bills for healthcare are usually sent to the patient but are difficult to interpret by the patient as to what has been paid and what is still owing. The reimbursement industry attempts to shift costs to the patient or family and the patient/family has no control or input into this cost shifting. The primary care provider 101 also initiates various types of out patient care such as out patient surgery, diagnostic and therapeutic radiology and home health care with little input from the patient or their family 104. In this provider centric system of health care, the care is largely directed toward treating medical problems rather than preventing problems from developing. Patients come to physicians with an illness and want treatment. At that time the physician makes the decision as to the care needed because the patient's are largely ignorant of the medical system. As such, the patient or their family has little input into the treatment to be provided or alternatives available.

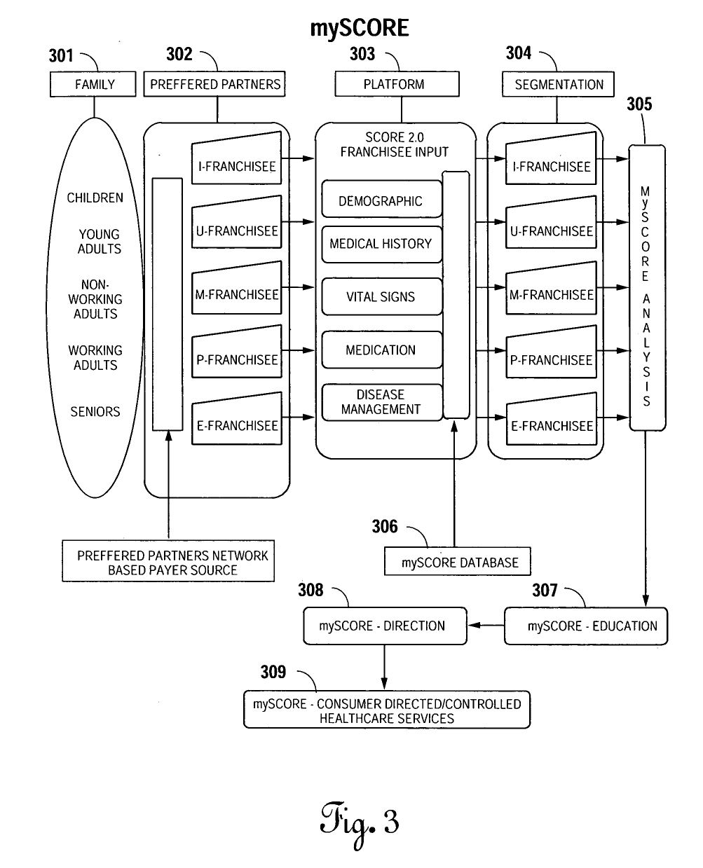

The Online Health Management System described herein is a method for health awareness and wellness, is family-centric and divides the family into five sectors based on age, employability & current insurance as shown in FIG. 2. In this model the family 201 consists of senior members 206, working members 204, non-working members 205, young adults 203 and children 202. The Online Health Management System evaluates the potential health insurance benefits or other potential third party payor which may be available to provide funds to pay for health care. Again as shown in FIG. 2, children 202 may receive health benefits from Medicaid 202a, private insurance 202b, a parent's employer funded health plans 202c or be uninsured 202d. Young adults 203 may have potential health benefits from Medicaid 203a, private insurance 203b, a parent's employer health plan 203c, or be uninsured 203d. The non-working family member 205 may receive health benefits from the spouse's employer funded health plan 205a, private insurance 205b, or be uninsured 205c. The working members 204 of the family may receive benefits from employer provided health plan 205a, private insurance 205b, or be uninsured 205c. The seniors 206 of the family may receive health benefits from Medicare 206a, private insurance 206b, employers insurance 206c or be uninsured 206d. Each of the potential health benefit sources including employer funded health plans, private insurance, Medicare, Medicaid and uninsured sources of support are entered into the database and analyzed to discover the schedule of benefits provided by each source. These schedule of benefits are then conveyed to the family so that optimal use of the available benefits may be made in order to protect and promote the family health.

The method used to promote and protect health used by the Online Health Management System is illustrated in FIG. 3. Information such as demographics, past medical history, present medical condition 303 and the like are collected from the family members 301 and stored in the database 306. Vital signs 303 such as blood pressure, blood sugar level, cholesterol level, triglyceride level and body mass index are collected for comparison to future vital sign measurements. As mentioned previously, the vital sign measurements are compared to published standards for normal range and a value is assigned to each vital sign 303 depending on how “normal” the value is. The vital signs are averaged and an overall health score (myscore) is obtained. The health score is evaluated on a 100 point scale with 1 representing minimal risk of disease development and 100 representing extreme risk of disease development. In this way the healthwatcher of the family can readily determine the relative risk for disease development by examining the health score value of each family member.

The health score is not a static value but is periodically updated. The Online Health Management System contracts with health providers according to the family members available health insurance benefits to periodically visit the family and collect new specimens or information regarding the individual's vital signs. 303. These values are entered in to the database 306. Over a period of time a number of vital sign measurements are made and the Online Health Management System collates and analyzes the vital sign measurements 303 and communicates those trends to the healthwatcher. As mentioned above the health insurance benefits for each family member is analyzed for potential benefits 304. On FIG. 3 the I-franchisee is the conglomerate of health care benefits for the entire family. The U franchisee is the uninsured benefits available for those who lack any health insurance. The M-franchisee is the Medicaid-Medicare or government sponsored schedule of health benefits. The P franchisee is the schedule of benefits provided by Private insurance 304. The E franchisee is the employer funded health plan. The benefits provided by each plan are evaluated by the Online Health Management System 305 and conveyed to the healthwatcher 308 who thus informed, can make sure the available benefits are used effectively and proactively.

The effective and proactive use of health benefits is guided by the health score 305 prepared from the analysis of the vital sign determinations. The health score 305 serves an education function 307 for the healthwatcher as to the risks to her family's health. The health score 305 then directs the healthwatcher 308 to the healthcare provider of her choice on her timetable 309.

The Online Health Management System disclosed herein is not restricted for use by the health care team only. In one embodiment is a system for communication between health care providers when the patient is at home and being primarily treated by nurses supplied by a home health nursing agency. In this embodiment, the referring physician communicates the order for a home health nurse to attend to the patient. The home health nursing agency confirms receipt of the order and a nurse is assigned to visit the patient at the frequency ordered by the physician. The patient and the patient's family is also notified of the order as is the patient's insurance carrier or third party payor. Before going to see the patient, the nurse can access the system and review the patient's medical records to have a clear understanding of the nature of the patient's condition.

Shortly, after the nurses visit to the patient, the data regarding the nursing assessments and care provided can be recorded into the system for review by the physician or other health care providers participating in the care. Pictures of the patient demonstrating such things as wound healing, unusual bruises or rashes can be taken by the nurse, digitally entered into the database and reviewed by the physician.

In another embodiment of the invention disclosed in the present application, automated instruments which measure temperature, blood pressure, oxygen saturation and heart rate and rhythm can be connected to the system to allow a health care provider to monitor vital signs at all times.

In another embodiment of the system disclosed in the present invention concerns administrative and employment matters for the home health agency or other health care provider. The system disclosed herein can keep a record of each nurse's productivity including the care provided and to whom. The system of the present invention could also maintain payroll records, including deductions, vacation and sick time. Further, verification of nurses license, education, criminal and civil background could be determined and a record maintained.

Another embodiment of the invention of the present application is directed to providing a tool for the provision of health care to the entire family. As described generally above, the family's doctor and other providers would be integrated into the online system for communication and information management. Appointments with physicians could be made for each member of the family as determined in consultation with the family doctor. Information is provided to the family to help them make decisions about their health care. Information is also provided to help the family make wise decisions regarding the expense associated with health care. For example, information is provided about what conditions need to be attended to urgently in an hospital emergency room and which can be more economically treated at the doctor's office. Information is also provided regarding cost of procedures and drugs. All of which is aimed at making the family a wise consumer of health services. Through the provision of this information, decisions can be made by the family regarding the type and amount of insurance needed through the lifetime of the family members.

In another embodiment of the Online Health Management System and method disclosed in the present application, the healthcare benefits provided to the children of the family by government sponsored programs such as Medicaid are analyzed to discover what benefits are available to the family. Typically, programs such as Medicaid provide funds to pay for vaccinations, periodic examinations, screening for certain genetic disorders and treatment for various conditions. The Online Health Management System and method disclosed herein analyses the schedule of benefits provided by Medicaid and other government funded programs for children and advises the family's healthwatcher when a treatment, evaluation or examination are available to the child. In this way the healthwatcher of the family is advised when a child's vaccinations are due, when the child needs a physical examination and when additional health screenings are indicated and are scheduled to be paid for by Medicaid or other government funded program for children. By this Online Health Management System and method, the healthwatcher for the family can make full use of the benefits provided by Medicaid or other government funded program for children. The children receive the vaccinations, examinations and health screenings at the appropriate time and health problems are detected early when they are easier and cheaper to treat.

In another embodiment, the Online Health Management System and method disclosed herein will analyze the schedule of benefits provided to the family by employer-provided insurance. The healthwatcher of the family will be advised of the benefits provided by the employer-provided health insurance and when those benefits are available for use. In this way physical examinations, mammograms, PAP smears, prostate examinations, colonoscopies and the like can be scheduled at the appropriate time and at appropriate intervals so as to detect problems in their early stages.

In another embodiment, the Online Health Management System and method disclosed herein will analyze the schedule of benefits provided to the family by private health insurance. The healthwatcher of the family will be advised of the benefits provided by the private insurance and when those benefits are available for use. In this way physical examinations, mammograms, PAP smears, prostate examinations, colonoscopies and the like can be scheduled at the appropriate time and at appropriate intervals so as to detect problems in their early stages.

In another embodiment, the Online Health Management System and method disclosed herein will analyze the schedule of benefits provided to those members of the family eligible to receive Medicare, Medicare Supplemental Insurance or other government sponsored health care for senior citizens. The healthwatcher of the family will be advised of the benefits provided by Medicare, Medicare supplemental insurance and other government funded programs and when those benefits are available for use. By this method, full benefit can be derived from programs such as Medicare, Medicare supplemental insurance and other government funded programs so as to make the “golden years” for the senior family member as healthy as possible.

In yet another embodiment, the Online Health Management System and method described herein can assist the family healthwatcher find medical care for those family members who are uninsured or underinsured. The Online Health Management System and method analyzes local sources of free or low cost medical care and advises the family healthwatcher of those sources of medical care for the uninsured or underinsured members of the family.

In another embodiment, the Online Health Management System and method disclosed herein will recommend a specific health care provider to care for a specific medical problem encountered by a family member. The family healthwatcher accesses the system and describes the health problem encountered. The Online Health Management System and method can recommend a primary health care provider who can treat the problem and who accepts the family's medical insurance. In the event the family does not have medical insurance, the system and method disclosed herein can refer the family healthwatcher to local sources of free medical care.

The Online Health Management System and method described herein can also assist both the family members and health care providers to be proactive in improving the overall health of the family. Each family member is evaluated according to their current physical health, past medical history and family medical history. Pertinent vital signs such as blood pressure, blood sugar levels, cholesterol, body mass index and other parameters are measured initially and periodically. The individual values are compared to known normal standards and a value is assigned to each value. All of the measured values and assigned values based on past personal and family medical history are averaged together for a health score. The health score value falls within a range of 1-100 with 100 representing an extreme risk of disease development and 1 representing a minimal risk of disease development. For example a 45 year old man with hypertension and an elevated BMI due to obesity might have a myscore value of 79 while his teenage daughter who is slim and athletic may have a health score value of 39. In this embodiment of the disclosed invention, the health score is used to identify improvements needed in health and make recommendations to the appropriate health care provider to handle those needs. Since vital signs are measured periodically, a new health score is generated which can be compared to previous health scores. By this method improvement in health score values can be ascertained and feedback as to the effectiveness of the treatment plan provided to the family and healthcare team. In our example above of the overweight, hypertensive 45 year old man, the system and method may refer him to a primary care physician for evaluation of the blood pressure, a nutritionist to assist with proper diet and a personal trainer at a gym for exercise to help lose weight. The system and method disclosed herein would also provide feedback to the family member and to the health care providers as to improvement, if any in overall health has been accomplished. Again, by way of example, if the health score for the 45 year old man had improved to 65 three months after starting proper nutrition and exercise, then the man and his health care providers would have positive feedback that what they were doing was helping. On the other hand, if the health score value changed very little in the next three months, that would be an indicator to the health care professionals that the current treatment plan was not working and that some other plan needed to be developed.

In yet another embodiment of the present invention, those entities responsible for reimbursement of medical care provided to the family could evaluate the medical care provided to the family and ensure that there was no duplication in service or costs. Discrepancies in what medical care was provided and what medical care for which bills were received could be reconciled easily without wasting valuable resources such as time and money in recouping duplicate payments for a single medical treatment.

Operationally, the Online Management Health System and method disclosed herein would be a system of computers linking the family, the family's health care providers and the family's health insurance. The methods for entry of data, maintenance of same, analysis of data, display of data, calculation of health scores and accession of data by authorized persons and the like are familiar to those of ordinary skill in the art. As described above the family would have access to all of their health care records as would the health care providers and health insurance providers. The family healthwatcher could evaluate the medical care provided to the family members with necessary explanation by the family's health care providers. The family healthwatcher would act as a “check and balance” on other family members to insure that a family member was not abusing the health care system by obtaining narcotic medicines from numerous health care providers, for example. The health care providers could act as a check and balance on other health care providers to insure that one health care provider was not recommending a treatment that might conflict with a treatment ordered by another healthcare provider. The family healthwatcher could evaluate the cost of medical care and make informed decisions as to which and how much additional health care or health insurance is needed. The health insurance providers could access the medical information and insure that duplicate payments were not made for health care. The health insurance provider could also suggest more cost efficient alternatives for consideration by the family health watcher. All of these activities are provided by a computer link between the participants.

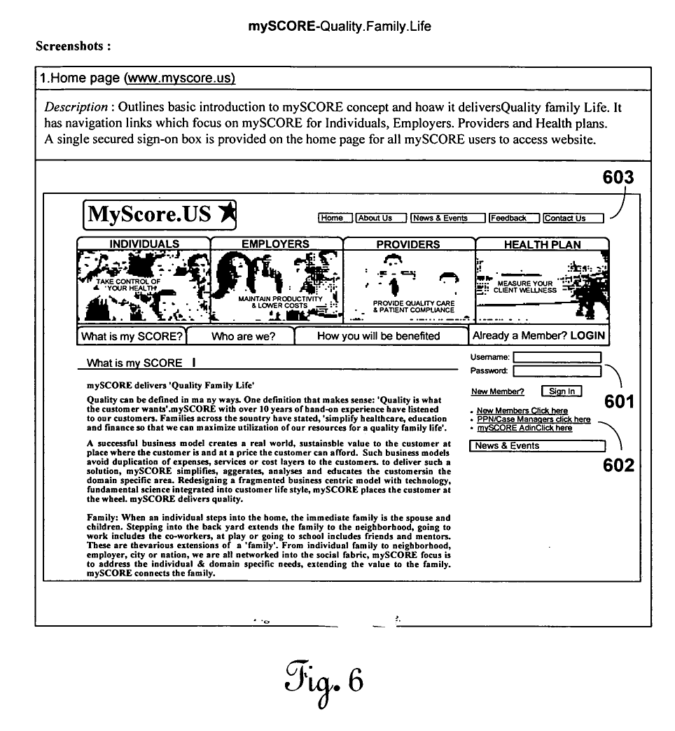

FIGS. 6-55 illustrate the information provided to the family as part of the Online Health Management System and Method disclosed herein. FIG. 6 is an interactive computer screen showing the home page of the Online Health Management System web site. Family members of the Online Health Management System select an user name and password which allows the member to access the system 601. Case managers can also access the Online Health Management System web site 602 for the purpose of evaluating the health care provided and future treatment plans. The Online Health Management System home page also provides basic information to nonmembers such as news and information on the services provided and contact information. The family's health care providers can also access the information contained in the database upon receiving authorization from the family.

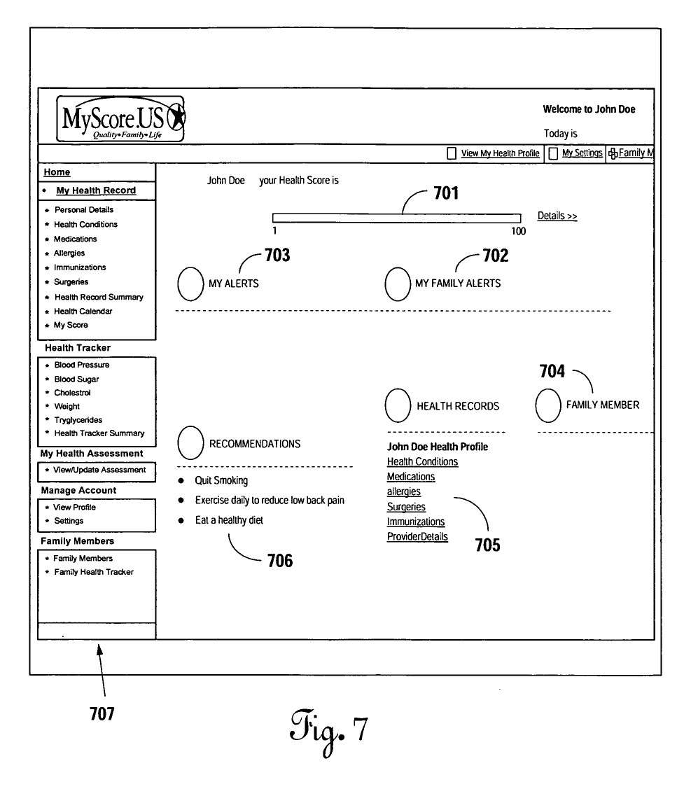

FIG. 7 displays user specific information such as and individual's health score 701, individual alerts 703, family alerts 702 and future recommendations 706 for preserving and improving an individuals health. Access to other family members specific information is also available 705, as are specific details regarding the individuals health profile 704. The Online Health Management System also provides a tool bar 707 to permit the user to navigate to other records in the data base.

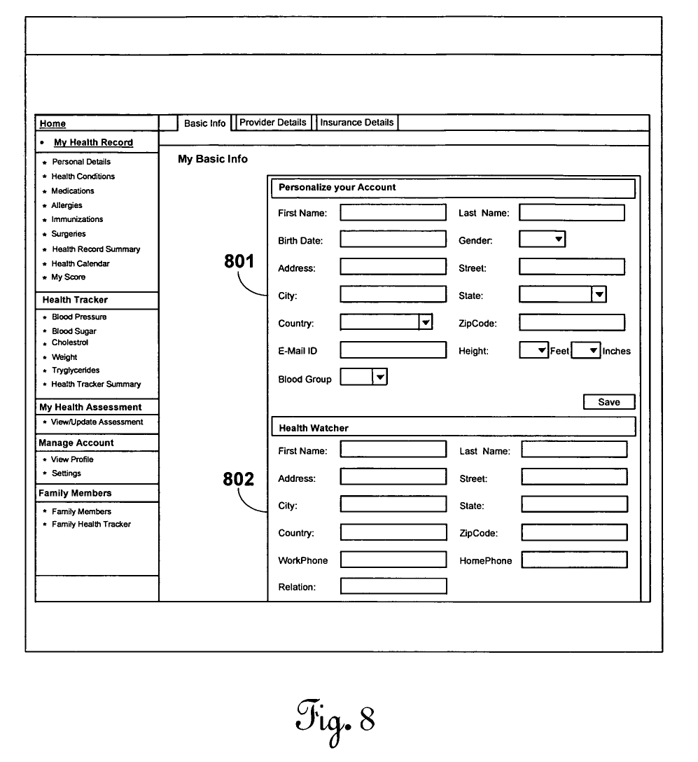

FIG. 8 is an interactive screen with access to the Online Health Management System database which permits entry of basic information such as name, birthrate, address, contact information, blood group and height 801. Also, the individual can designate the authorized healthwatcher 802, which as described above is the individual in the family charged with the responsibility of keeping track of medical appointments and encouraging family members to adopt healthy habits for the promotion and preservation of good health.

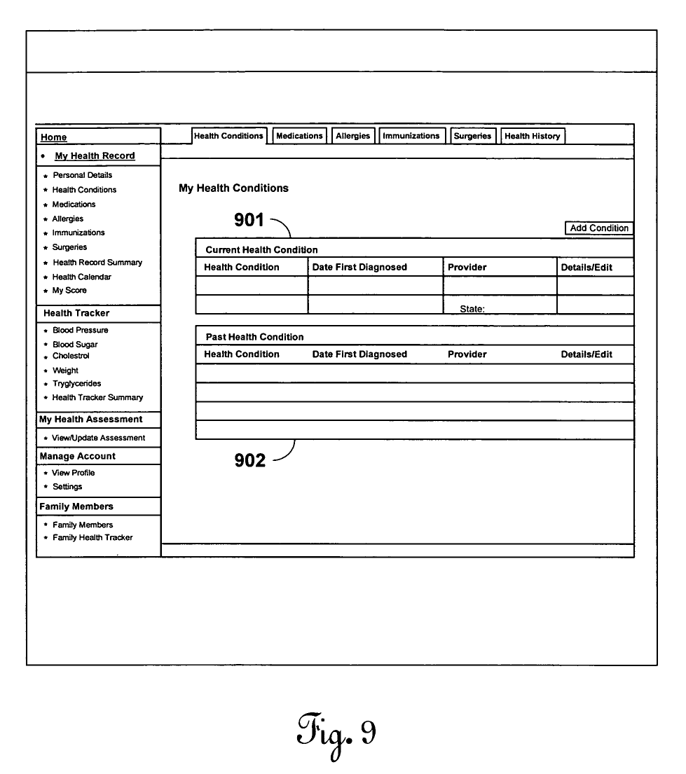

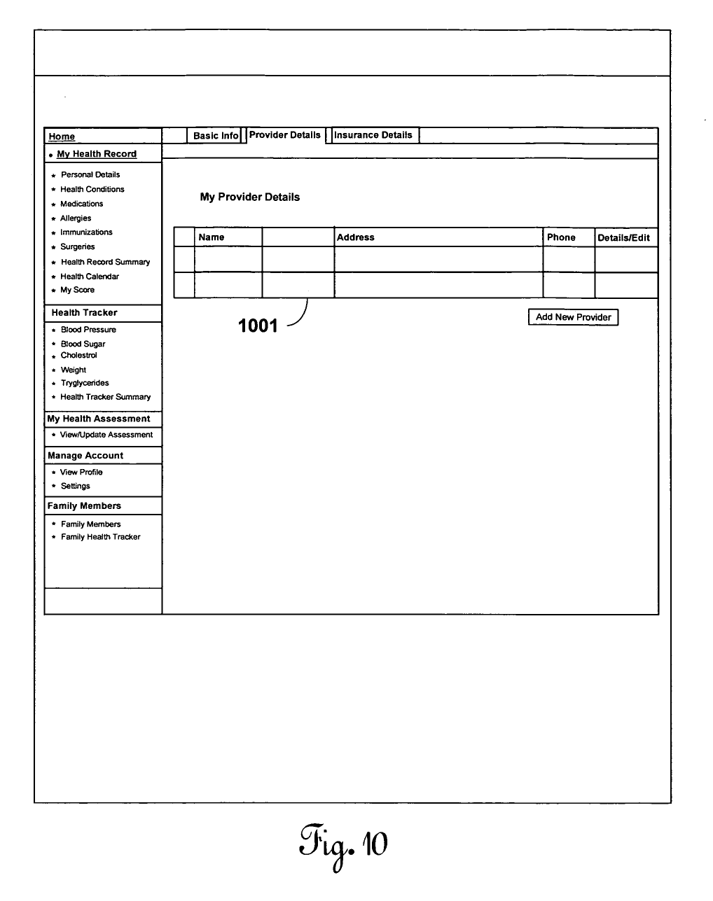

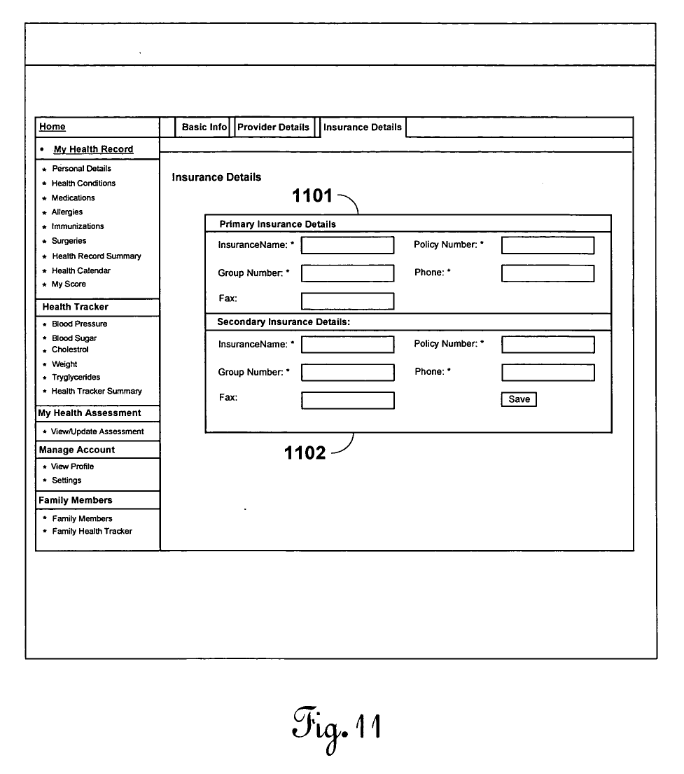

As shown in FIG. 9 family members of the Online Health Management System disclosed herein are permitted to enter into the system data base information regarding their current health 901 and past medical history 902. The member is invited to identify their primary health care providers 1001 as shown in FIG. 10. Basic information regarding primary 1101 and secondary 1102 health insurance providers is entered as shown in FIG. 11. Information such as the name of the insurance provider, policy number and contact information are entered to enable the Online Health Management System to access those disclosed insurance policies and evaluate the schedule of benefits provided by the insurance provider and when those benefits would be available to the member.

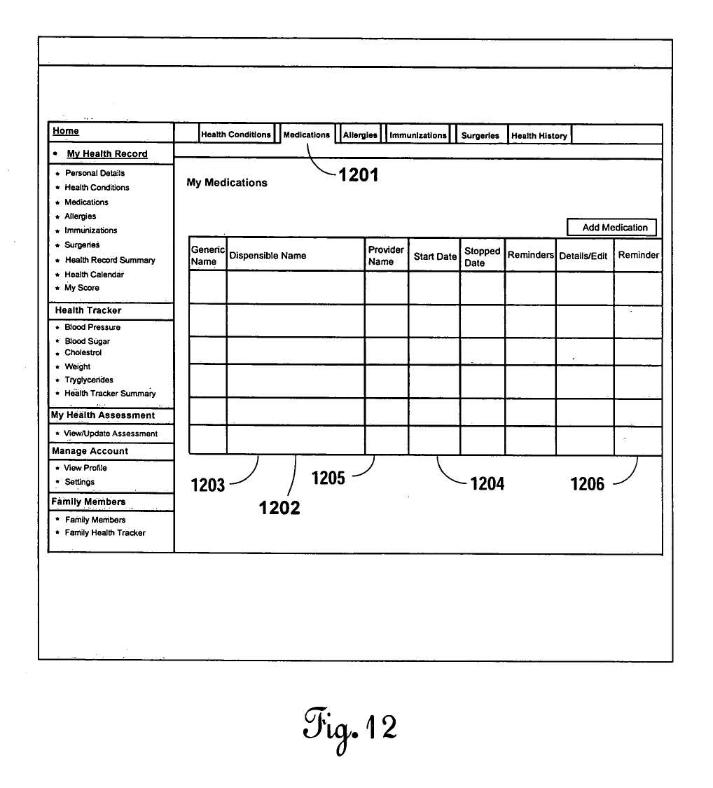

The Online Health Management System disclosed herein maintains a record of all medicines prescribed to an individual in the Online Health Management System as shown in FIG. 12. This computer screen is accessed through “medications” 1201 in the tool bar. All of the medicines 1202 prescribed for the individual are recorded along with information as to the dose of medicine 1203, the period of time the medicine is to be taken 1204 and the identity of the physician who prescribed the medicine 1205. The interactive screen shown in FIG. 12 will also permit the individual to receive a reminder 1206 of when medicine should be taken which will appear on the individual alert screen 703.

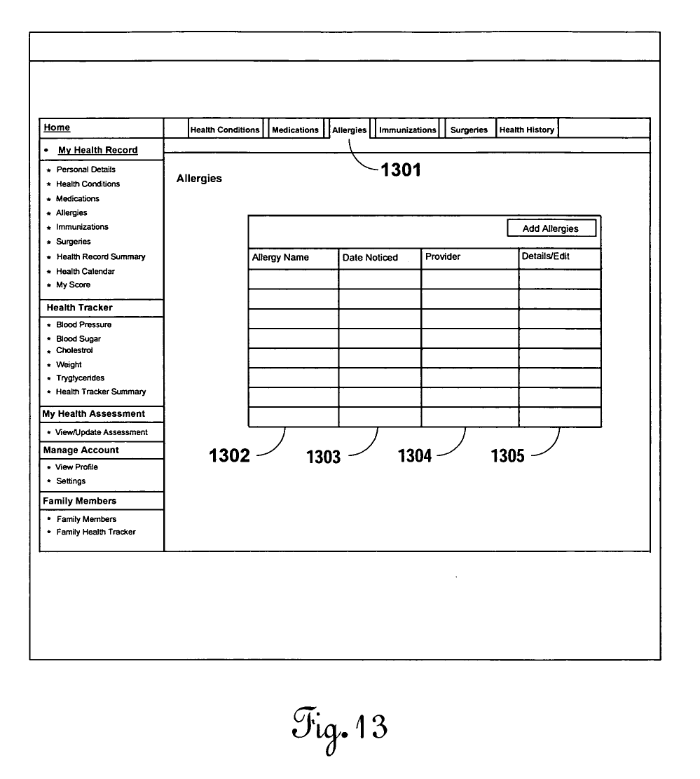

The Online Health Management System disclosed herein will also record an individual's allergy history as shown in FIG. 13. This computer screen of the Online Health Management System is accessed through the “allergies” portal 1301 of the screen's toolbar. The identity of the allergen 1302, when the allergy was first observed 1303 and the identity of the physician 1303 who is caring for the problem is displayed. An individuals history of allergy can be edited or a new allergy added through this screen 1305. Maintenance of the information regarding allergies would alert all health care providers to this critical information and prevent prescription of a drug to which the patient is allergic, for example.

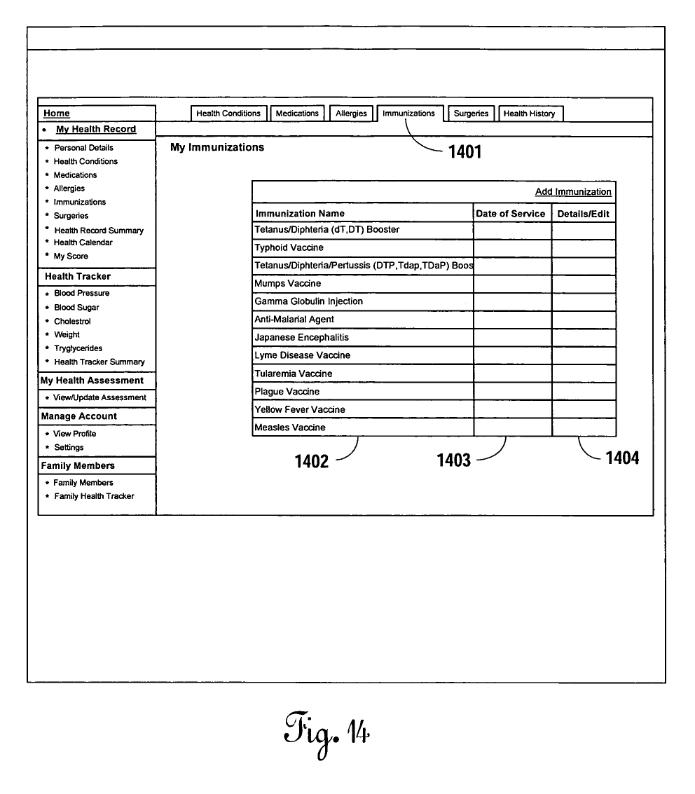

In many localities certain immunizations are required before a child my attend school. Travel to certain countries in the world is permitted only after certain immunizations have been received. The Online Health Management System disclosed herein keeps a record of all immunizations received as shown in FIG. 14. The immunization record is accessed through the “immunizations” 1401 portal of the screen's tool bar. Each immunization 1402 received and the date it was received 1403 is recorded. New immunizations can be added and existing immunizations can be edited or details of the immunization revealed 1404.

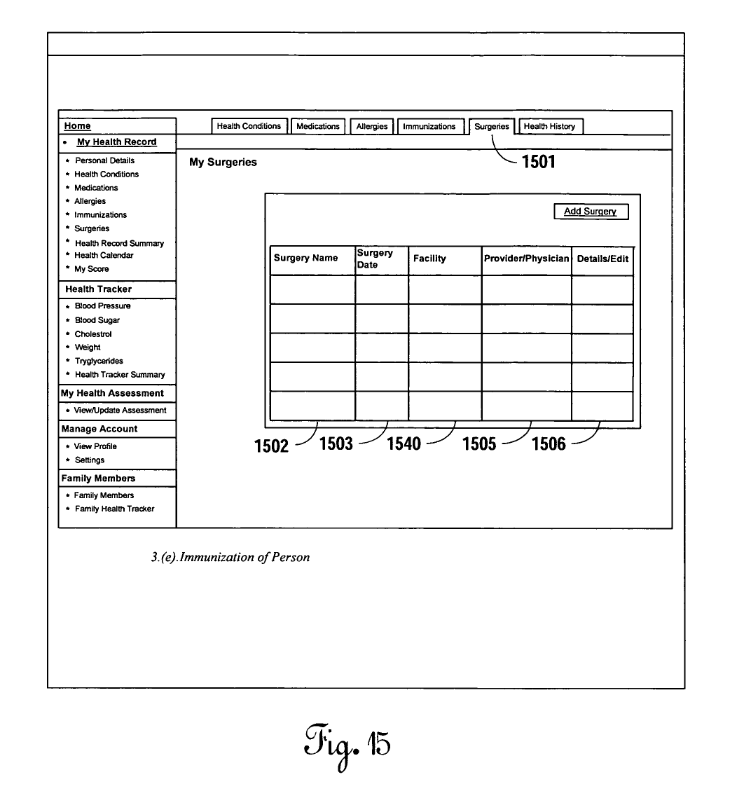

During the course of an individual's life, many different medical treatments and surgeries may be received and the Online Health Management System disclosed herein will maintain a record of each of them as shown in FIG. 15. The computer screen shown in FIG. 15 is accessed through the “surgeries” 1501 portal in the screen toolbar. Each treatment and surgery 1502, the date of the treatment or surgery 1503 is displayed as well as the facility 1504 in which the surgery/treatment was performed and the identity of the physician 1505 who performed the surgery/treatment. The record of surgeries and treatments shown in FIG. 15 can be edited or additional details of the surgery/treatment obtained 1506. Of course, new surgeries/treatments can be added as necessary 1507.

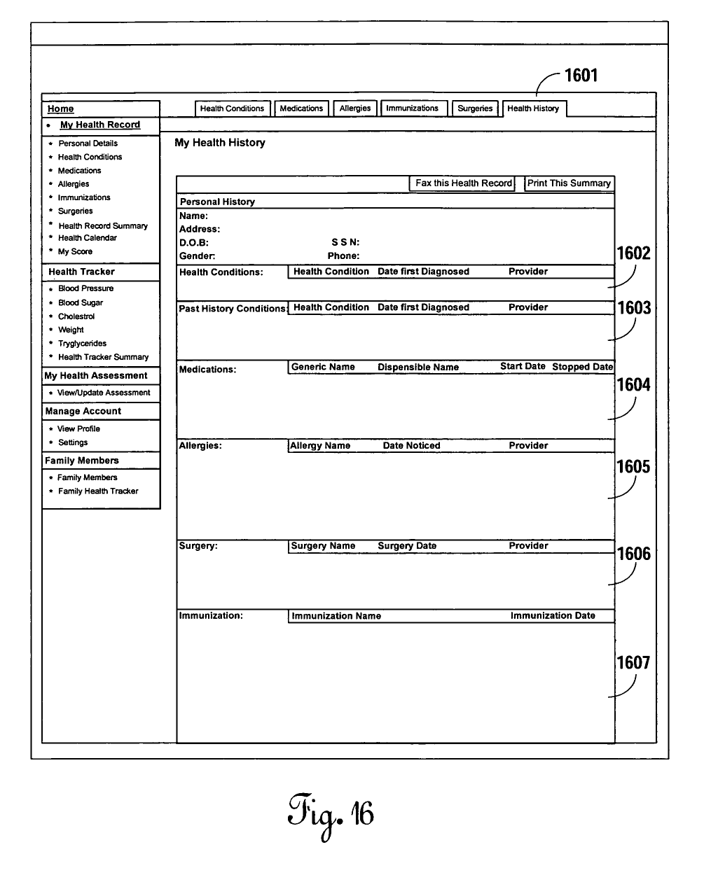

As shown in FIG. 16, a summary of a person's health history can be obtained through the health history portal 1601 of the My Health Record portion of the Online Health Management System described herein. The health information shown in FIGS. 9, 12, 13, 14 and 15 can all be displayed on one screen as shown in FIG. 16. The present health conditions 1602, past health conditions 1603, prescriptions 1604, allergies 1605, surgeries/treatments 1606 and immunizations 1607 are all displayed in a convenient format for review.

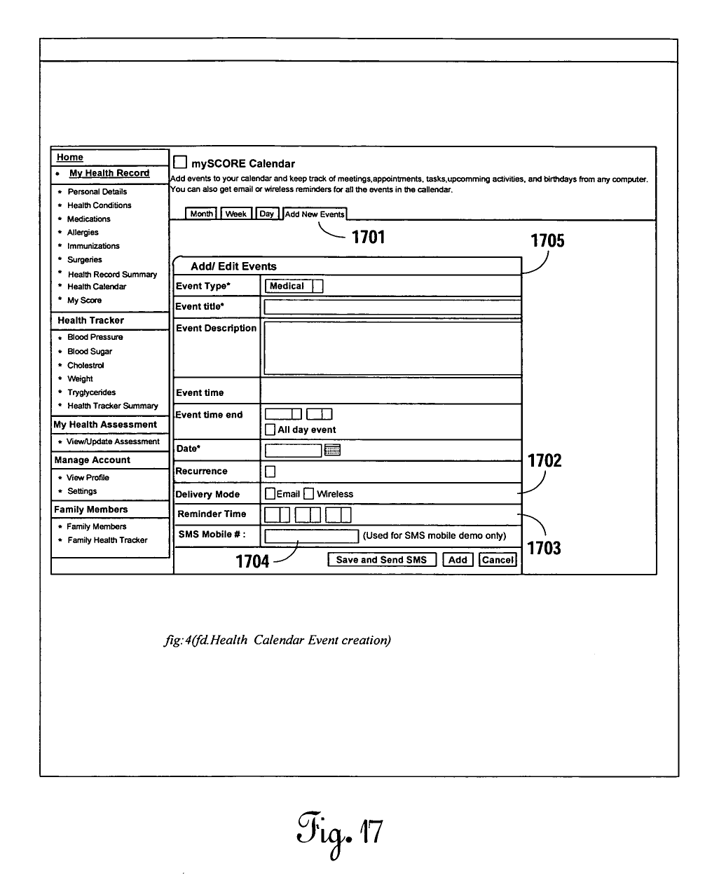

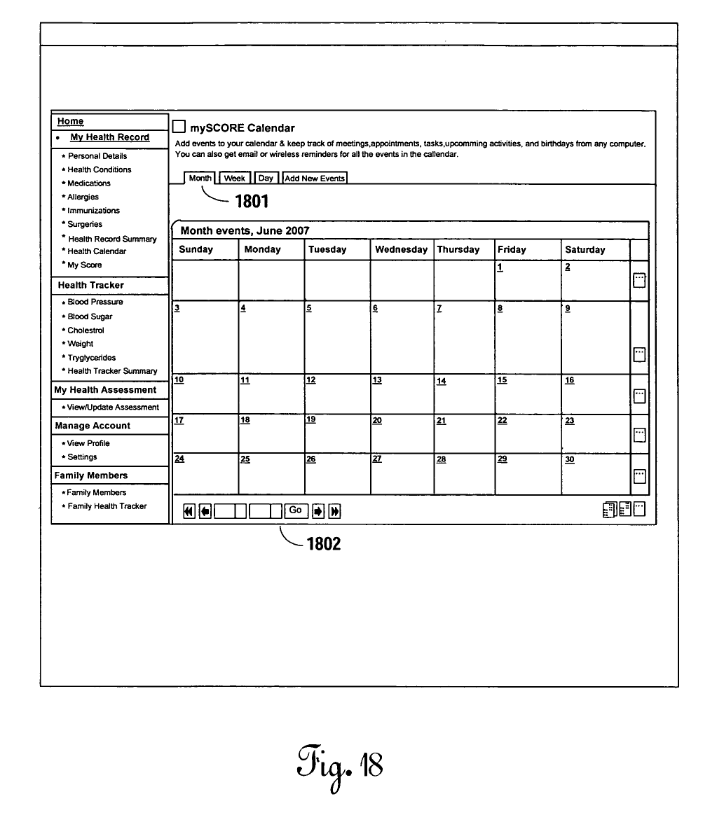

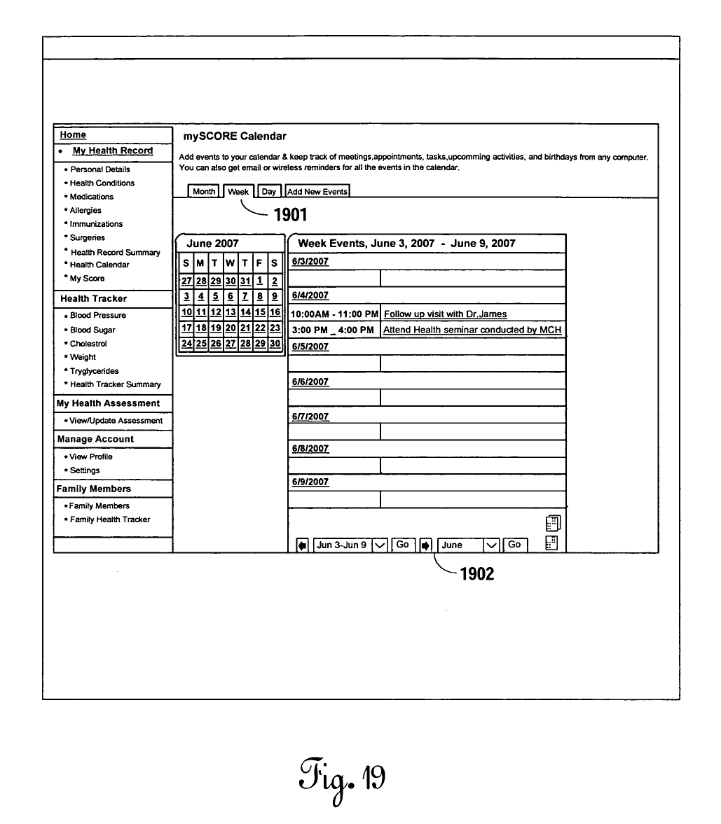

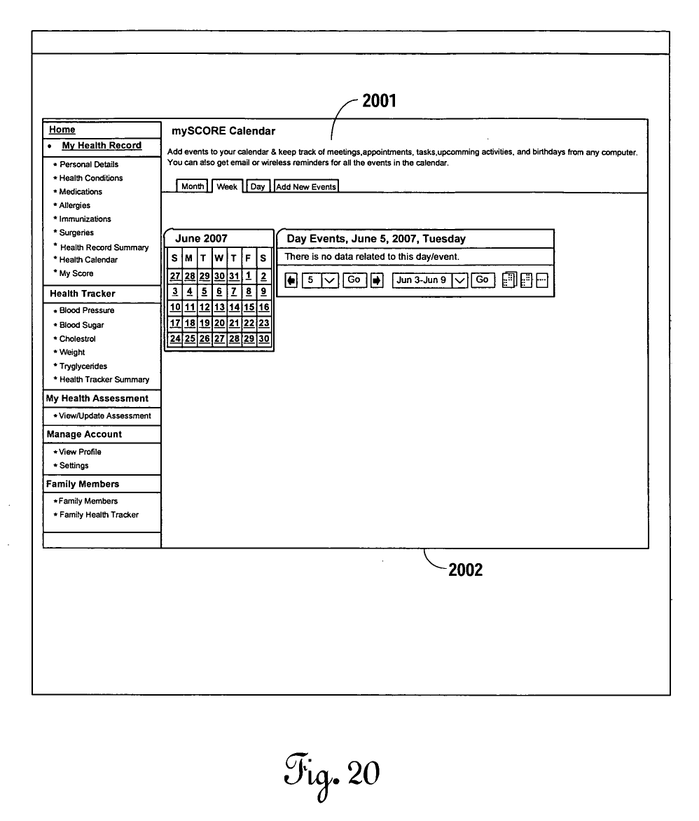

As shown in FIGS. 17-20, the Online Health Management System will maintain an appointment calendar for health appointments and other events and notify the member of an event by email or SMS text message as desired. The calendar is accessed through the “Health Calendar” folder 1705 by entering the “add new events” 1701 portal of the screen toolbar. The member can add information about the new event and request email or wireless reminder 1702 of the event. The member can even designate the time 1703 and the mobile number 1704 to which the reminder of the event is to be sent. Again by going to the health calendar folder 1705 and accessing the entry portal for the monthly calendar 1801, the member can see all recorded events for the designated month 1802 as shown in FIG. 18. As shown in FIG. 19, a weekly calendar of recorded events can be reviewed through the health Calendar folder 1705 by entering the portal 1901 for the weekly calendar on the screen toolbar. The weekly calendar is shown 1902 displaying all of the weeks recorded events. Finally, as shown in FIG. 20, the Online Health Management System will display a daily calendar of events and appointments 2002 by entering the appropriate portal 2001 of the Health Calendar folder 1705. From the foregoing it is clear that the member can have multiple means of access to a calendar reminder of events and appointments. By entering a family members folder and following the aforementioned steps, the calendar for each family member can be reviewed by the healthwatcher so that no important events or appointments are missed.

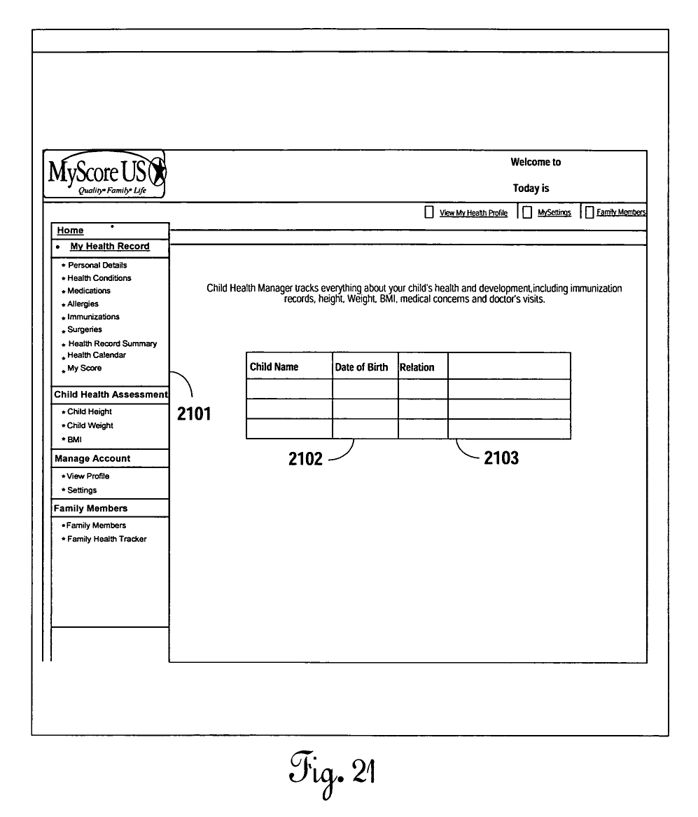

As shown in FIGS. 21-30, the Online Health Management System disclosed herein maintains a record of pertinent information regarding each child's health care. The child health manager incorporated into the Online Health Management System records information regarding each child's health and development, including immunization records, height, weight, BMI, medical concerns and doctor's visits. FIG. 21 shows the entry screen into the Child Health Manager. This screen is displayed through the Child Health Assessment folder 2101. The display screen shows the name, birth date and relationship of each child. 2102. A portal is also provided to enable the member to access the child's health profile 2103.

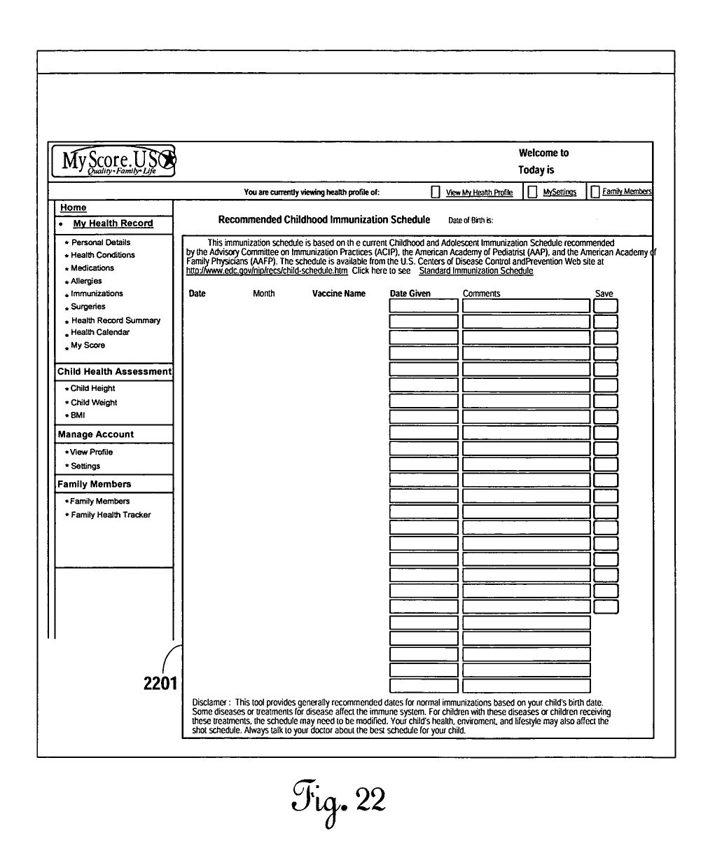

As mentioned above the child health manager will record details of a child's medical care including vaccination schedule as shown in FIG. 22. The vaccination schedule includes the date when vaccinations should be given to children. That date is calculated from published recommendations on vaccinations by physician groups and governmental agencies such as the Centers for Disease Control and Prevention. Based on the child's birth date, the date in which a particular vaccination should be given according to the recommendations of the aforementioned groups is provided 2201.

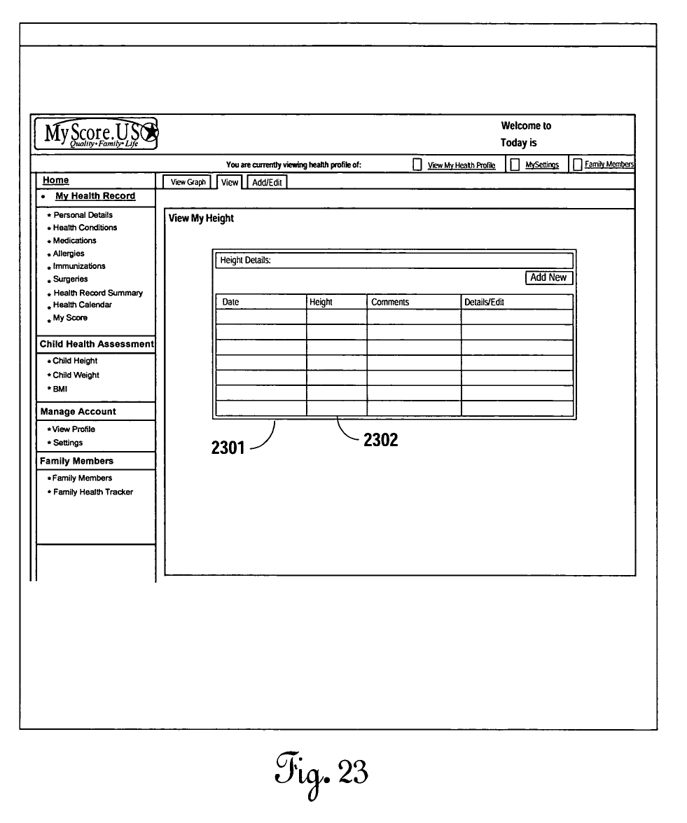

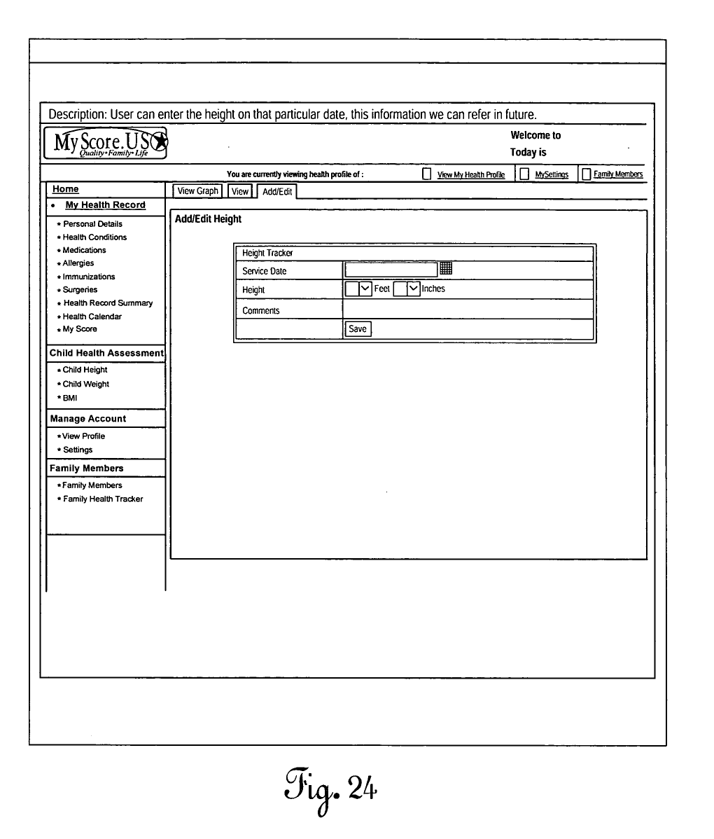

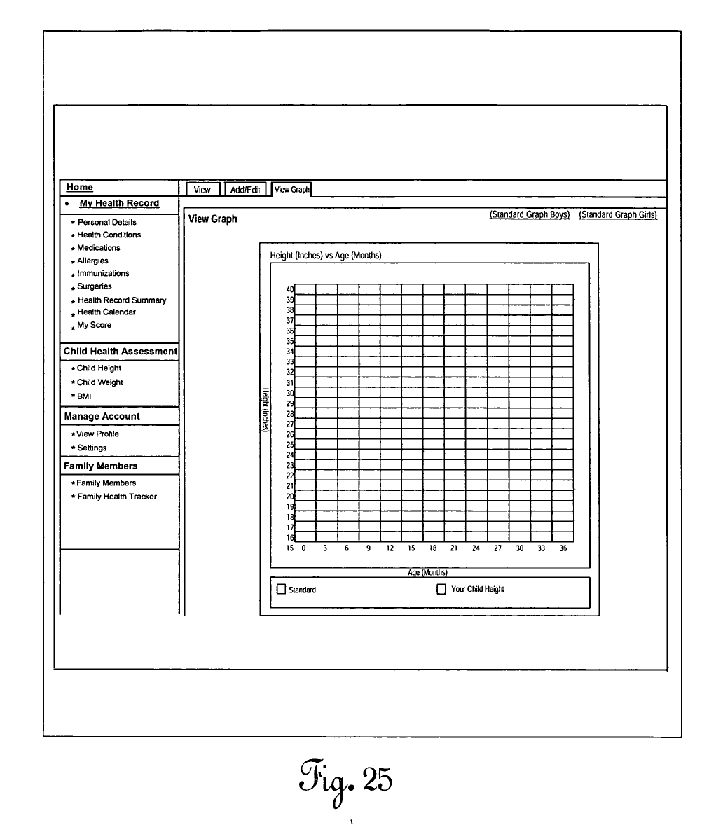

The Online Health Management System disclosed herein maintains a record of the height of a child in both tabular and graphic form as shown in FIGS. 23, 24, and 25. As shown in FIG. 24 the healthwatcher or other member of the family can add the measured height of the child and enter the date on which it was recorded. As shown in FIG. 23 the date 2301, and height 2302 are displayed in tabular form. However, knowing a child's height is not, in and of itself, particularly useful to the healthwatcher or healthcare provider. Thus, the Online Health Management System provides a comparison of the increase in a child's height with published standards for growth as shown in FIG. 25. In this way, the healthwatcher and healthcare provider can get an instant update on the child's growth as compared to published standards. This comparison can be periodically updated by entry of new height measurements through the screen shown in FIG. 24.

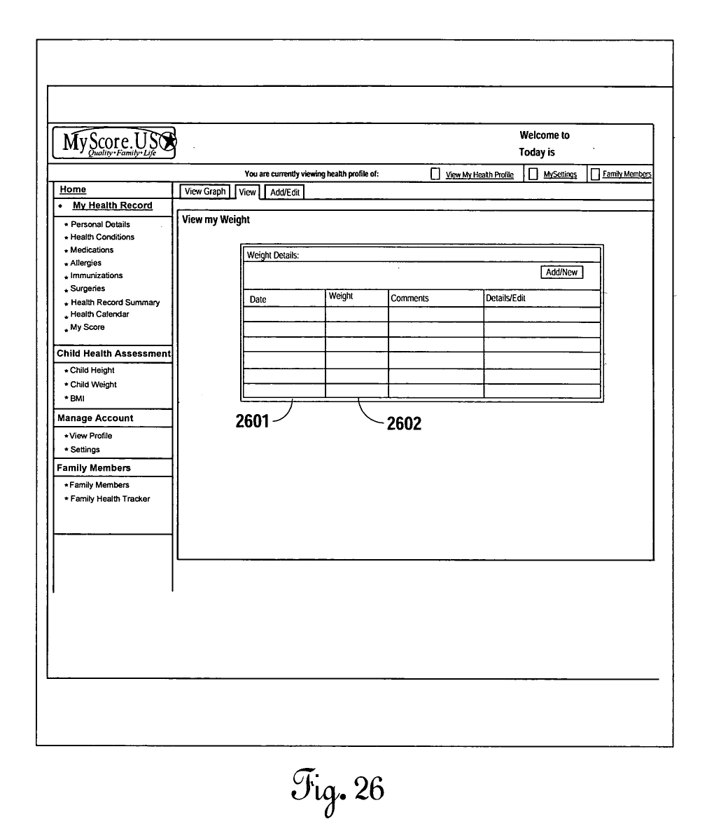

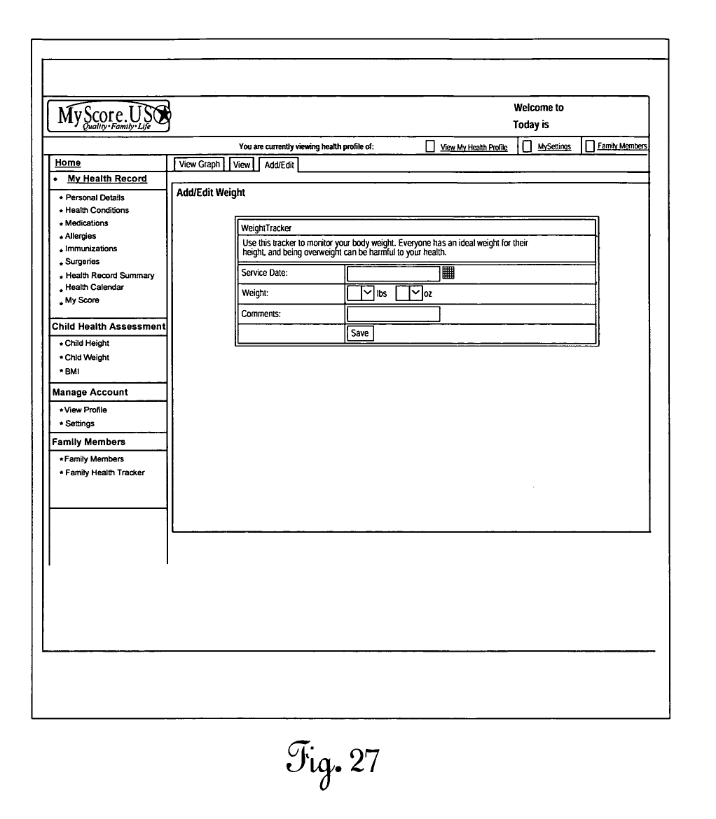

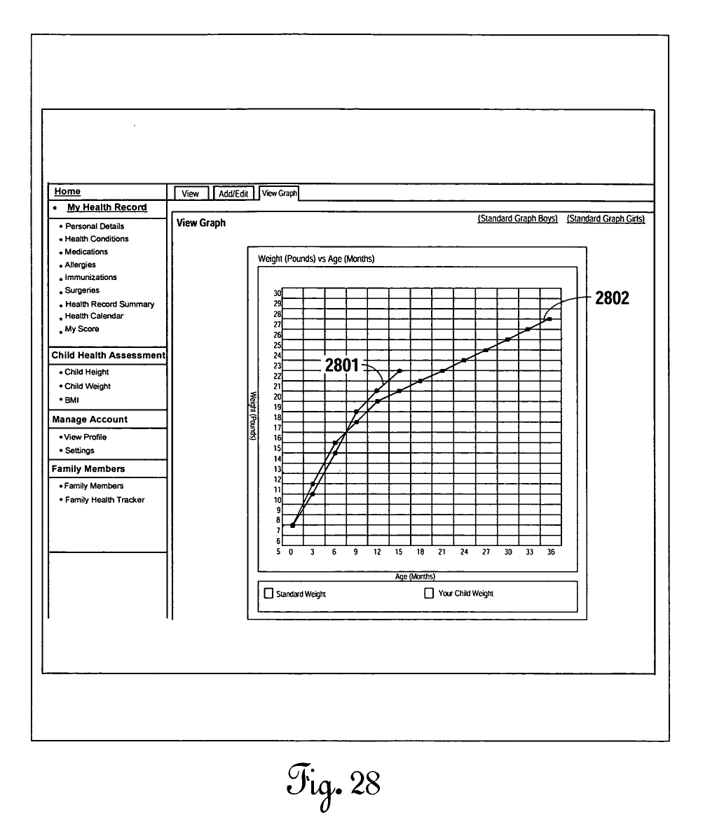

Proper recording of a child's weight is important information enabling the healthcare provider and family healthwatcher to monitor the development of a child. Like, height measurements, the Online Health Management System records weight entries and displays those entries in either a tabular or graphic form according to the date in which the measurement was made as shown in FIGS. 26, 27 and 28. The data entry screen shown in FIG. 27 enables the healthwatcher or other family member to record each measurement of a child's weight and the date on which the measurement was made. The data regarding weight is displayed in tabular form as shown in FIG. 26. In the aforementioned table, weight 2602 is displayed in order of the date in which it was entered 2601. The data regarding weight is displayed in graphic form as shown in FIG. 28. The child's weight 2801 is plotted against time and compared to a standard weight curve 2802. By having the child's weight 2801 compared to published standards for weight 2802, information is provided to the healthwatcher and healthcare provider as to the development of the child as measured by increase in weight as compared to other children of the same age. Problems in physical growth and development can be quickly detected and potentially treated by evaluation of the height and weight graphs shown in FIGS. 25 and 28, respectively. This data may not be readily available if the data is collected by various health care providers and not recorded in a central location where the family healthwatcher can review the information periodically and alert a healthcare provider of a potential problem.

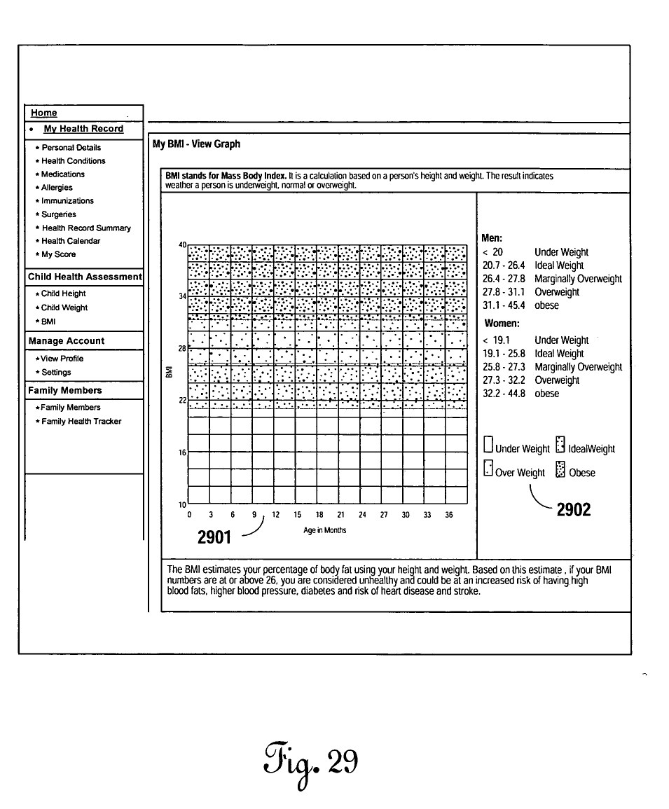

Data regarding height and weight is also helpful in determining the Body Mass Index (BMI). Body Mass Index is an estimate of the percentage body fat carried by an individual. As shown in FIG. 29, the Online Health Management System calculates the BMI for each family member and displays the information as a graph of BMI at various time periods. 2901. Interpretive data is provided 2902 to enable the healthwatcher to gauge whether a family member is at the ideal weight or not. Since the BMI is periodically updated when new height and weight entries are made, the healthwatcher can determine if a family members efforts to achieve the ideal weight are effective. If the efforts to achieve the ideal weight are not effective, the fat-loss plan can be altered to achieve maximum results.

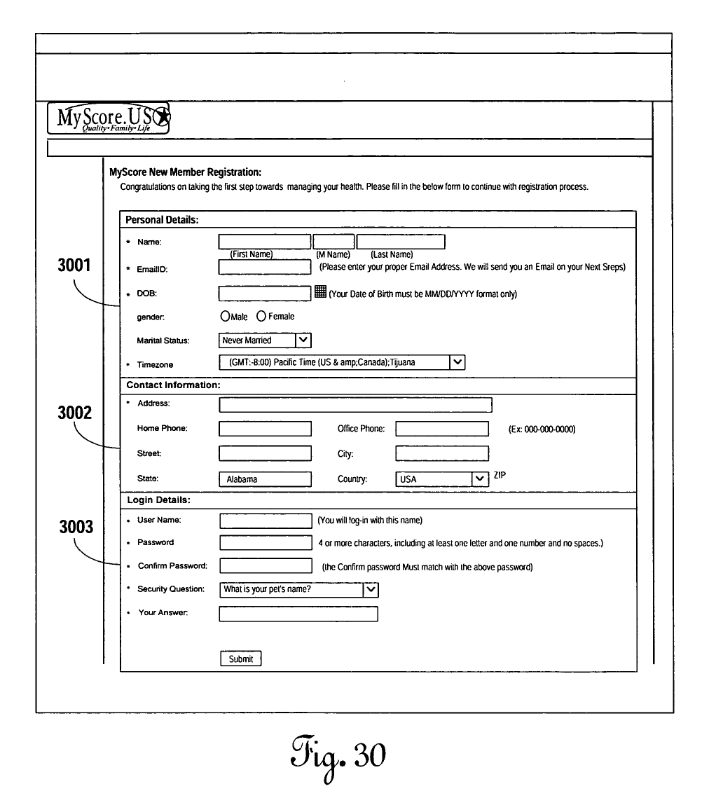

The size of the family may increase either by a new birth or in the circumstance when a grandparent or other member of the extended family comes under the care of the family healthwatcher. The Online Health Management System disclosed herein provides an interactive screen for entry of information regarding the new member as shown in FIG. 30. Information regarding personal details 3001, contact information 3002 and computer security login data 3003 can be entered. Once the new member is entered into the system, medical information can be entered into the system for management of the new member's health needs.

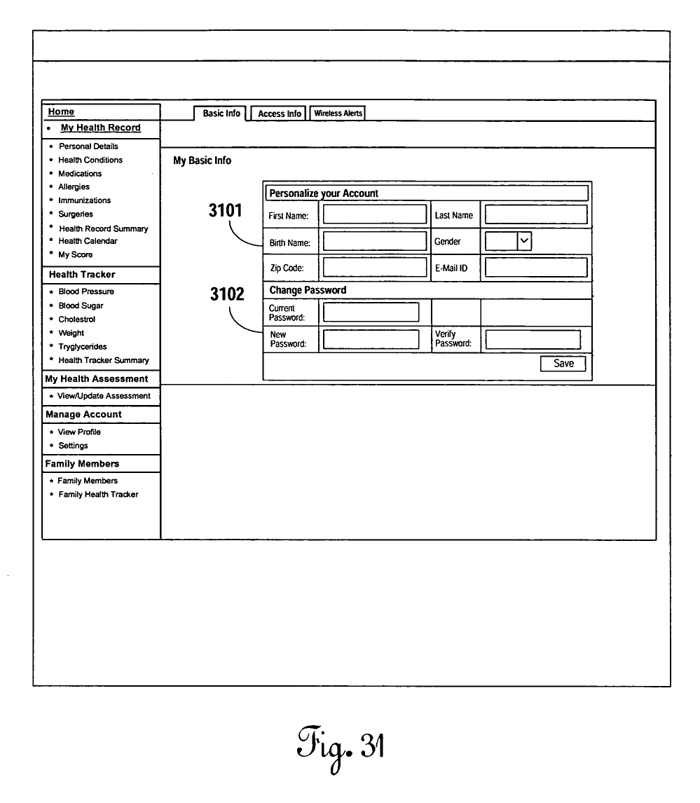

For security of an online data base, it often becomes necessary to change passwords so as to prevent unauthorized access to confidential information. The Online Health Management System disclosed herein permits a family member to change their password as shown in FIG. 31. The Online Health Management System provides an interactive screen which displays basic information about the individual 3101 and permits the individual to change passwords by entering the appropriate information into the spaces provided on the screen 3102. By this method a healthwatcher or family member can change passwords and prevent unauthorized access to the confidential health information stored in the Online Health Management System.

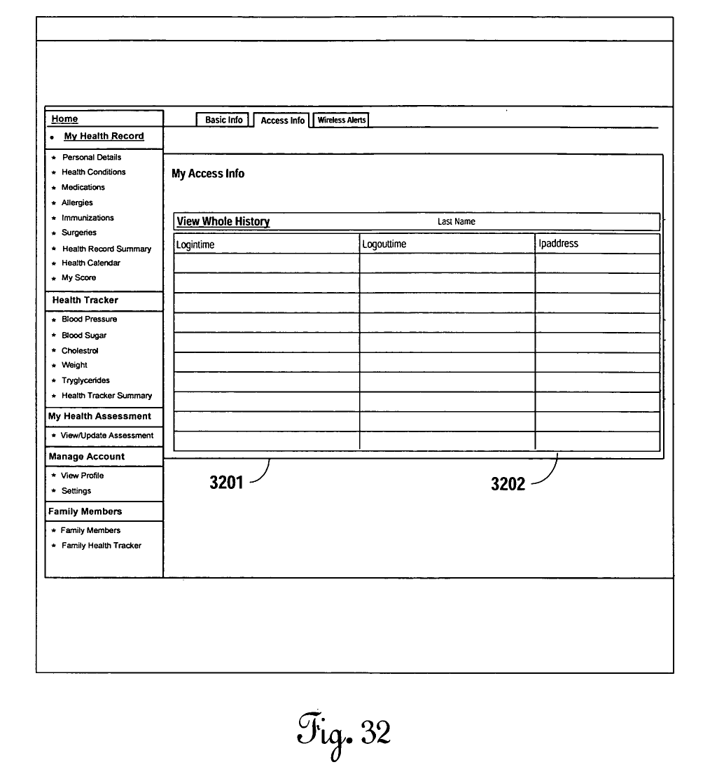

Since the Online Health Management System contains confidential health information about an entire family, a record of when an individual enters the online database is maintained as shown in FIG. 32. This feature of the Online Health Management System records the time, date and duration when each individual enters the online system 3201. Moreover, the Online Health Management System records the address of the computer from which access to the system was made 3202. This security feature of the disclosed invention helps identify who has entered the system and from which computer entry was made. In the event, that discrepant or corrupted data is encountered by the system, the source of the discrepant or corrupted data can be traced.

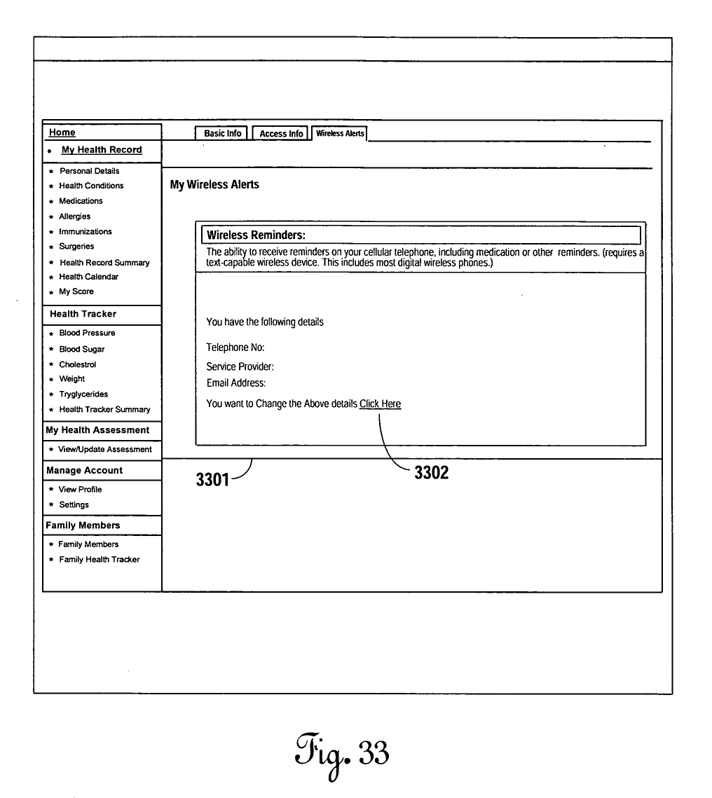

Reminders of appointments or events recorded in the calendar feature of the Online Health Management System can be sent by email or text message. The healthwatcher or other family member can identify which email address or cellular phone number is entered into the system to receive the wireless alert as shown in FIG. 33. The cellular phone number or email address identified to receive the wireless alert is displayed 3301. Should the healthwatcher or other family member want to change the device to receive the wireless alert, such device can be registered with the Online Health Management System through the entry portal on the computer screen 3302.

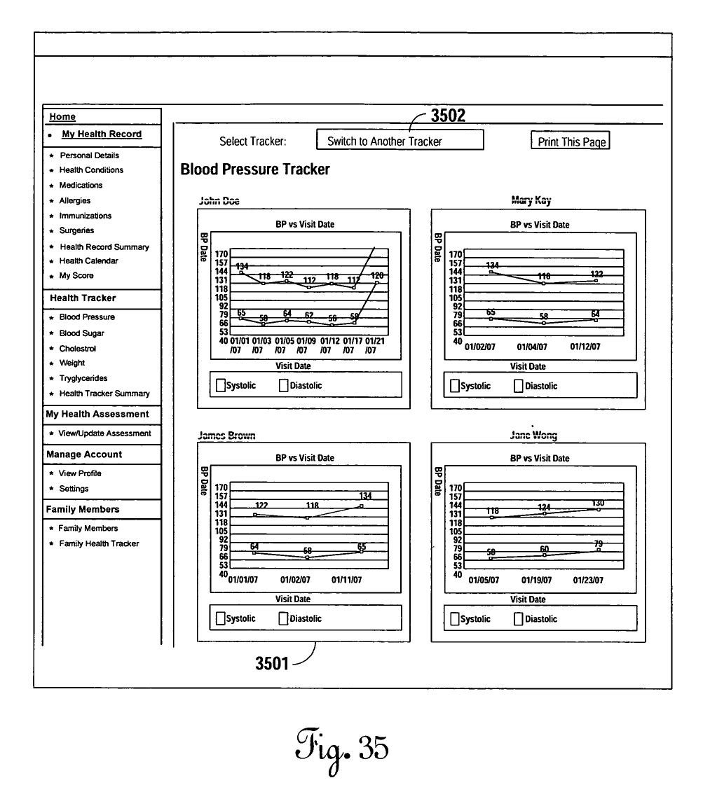

Previously, the central role of the family healthwatcher was discussed. It is that person's responsibility to follow the overall health of the family and make sure that everyone is attending to their health needs. The Online Health Management System of the present invention assists the family healthwatcher fulfill this duty by providing medical information about the entire family in one computer screen as demonstrated in FIG. 35. The blood pressure measurements for the entire family over a period of time are displayed graphically on one computer screen. At a glance the healthwatcher can evaluate the family's blood pressure records over a period of time. In that way the healthwatcher stays advised of any problems in her family's blood pressure which may need medical intervention. On this same screen demonstrated by FIG. 35, there is a navigation tool 3502 which permits the healthwatcher or other family member to switch to another health tracker such as the family's recorded data for blood sugar, cholesterol, triglycerides, height, weight and body mass index. In this way, the healthwatcher can quickly check on the vital signs tracked by the system and identify any abnormalities which may need medical intervention.

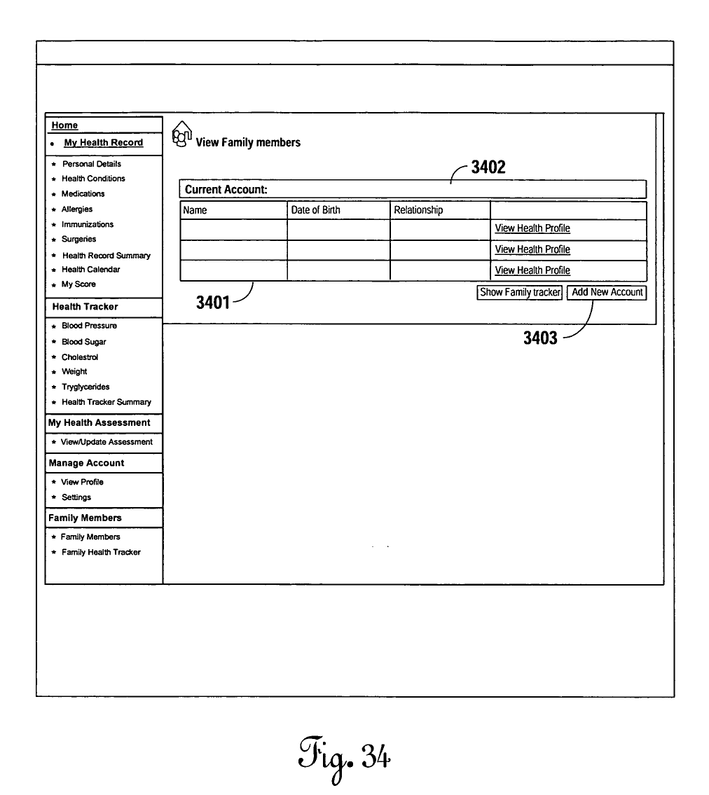

Family members come and go occasionally and the healthwatcher for the family may have to add new members to the family account or delete some family members such as in the circumstance when a child “leaves the nest” and strikes out on his own to start a new family or when a family member expires. Family members can be added or deleted from the Online Health Management System through the process demonstrated by the computer screen shown in FIG. 34. On this interactive screen, all of the current family members are displayed and an access portal to their health profile is provided 3402. New members can be added to the family account through the designated navigation tool 3403. By using this feature of the Online Health Management System, the healthwatcher or other family member can add new members to the family account.

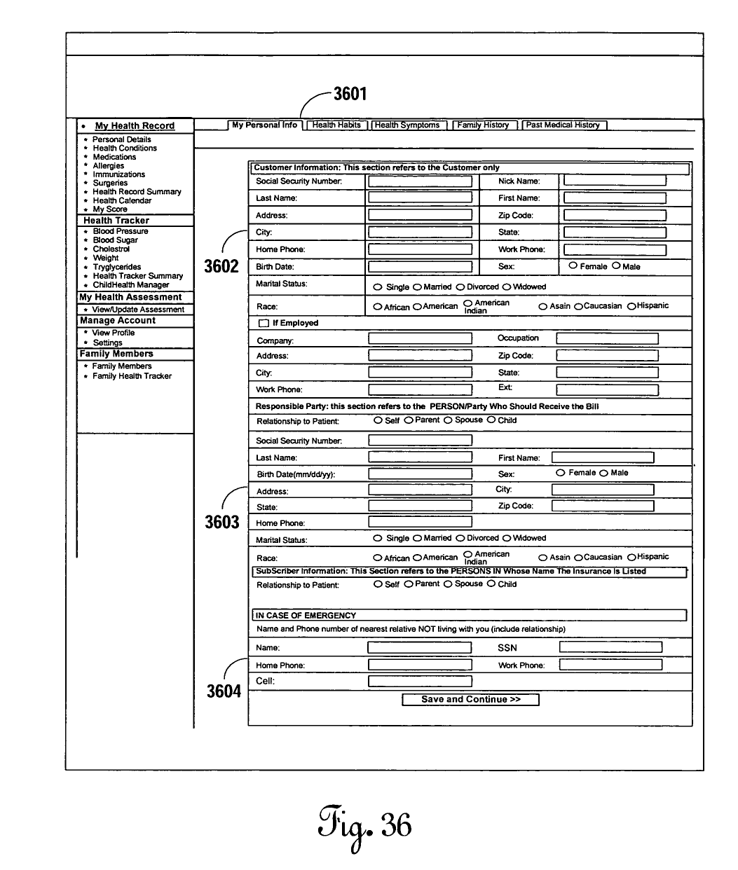

The information necessary to add a new member to the family's Online Health Management System are shown in FIGS. 36, 37, 38 and 39. In order to establish a new member account, basic information such as that shown in FIG. 36 is needed. Through the interactive computer screen information regarding basic demographic data 3602, current employment 3603, identity of the responsible party 3603 and emergency contact 3604 information is entered.

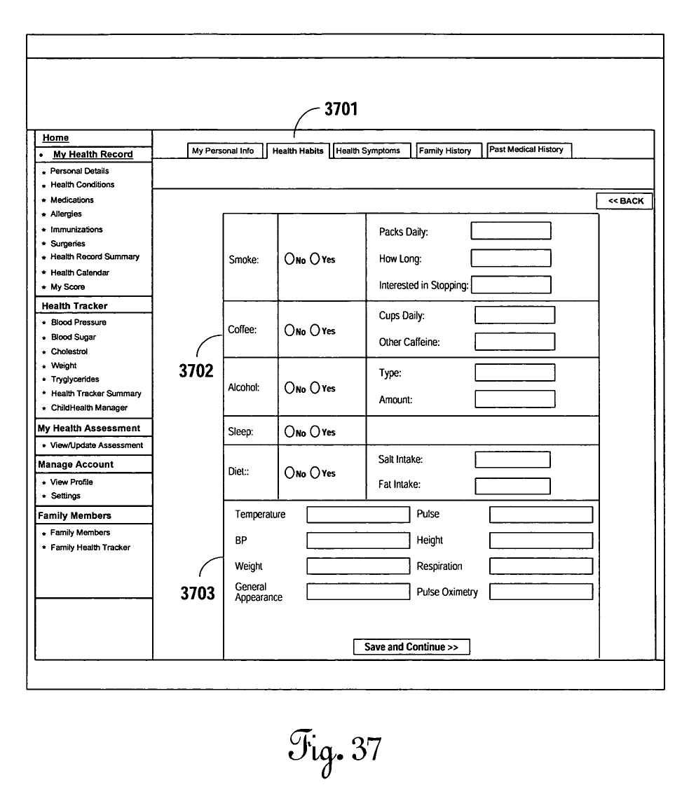

Basic information regarding health habits are entered into the Online Health Management System as demonstrated in FIG. 37. A person's habits can have important and deleterious effects on one's health. Habits such as smoking, alcohol, poor diet and the like can contribute to poor health. These health habits are entered into the Online Health Management System through the interactive screen shown in FIG. 37. Information such as an individual's smoking habit and duration, coffee consumption, alcohol consumption and diet information 3702 are input into the Online Health Management System. Through the interactive computer screen demonstrated in FIG. 37, the healthwatcher or health care provider can add basic vital sign information such as temperature, blood pressure, pulse, respiration, oxygen saturation, height and weight can be included 3703.

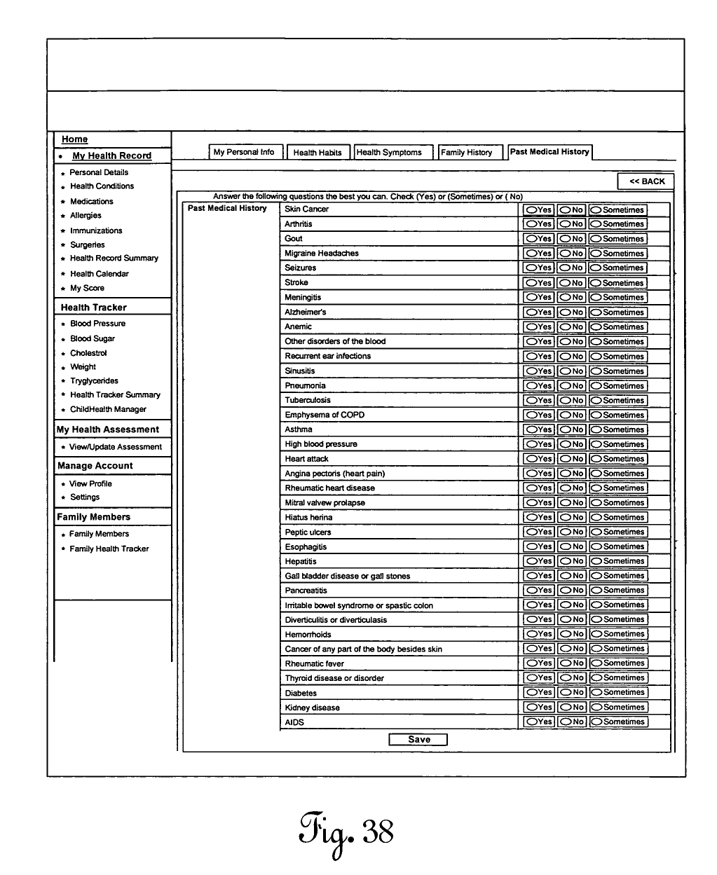

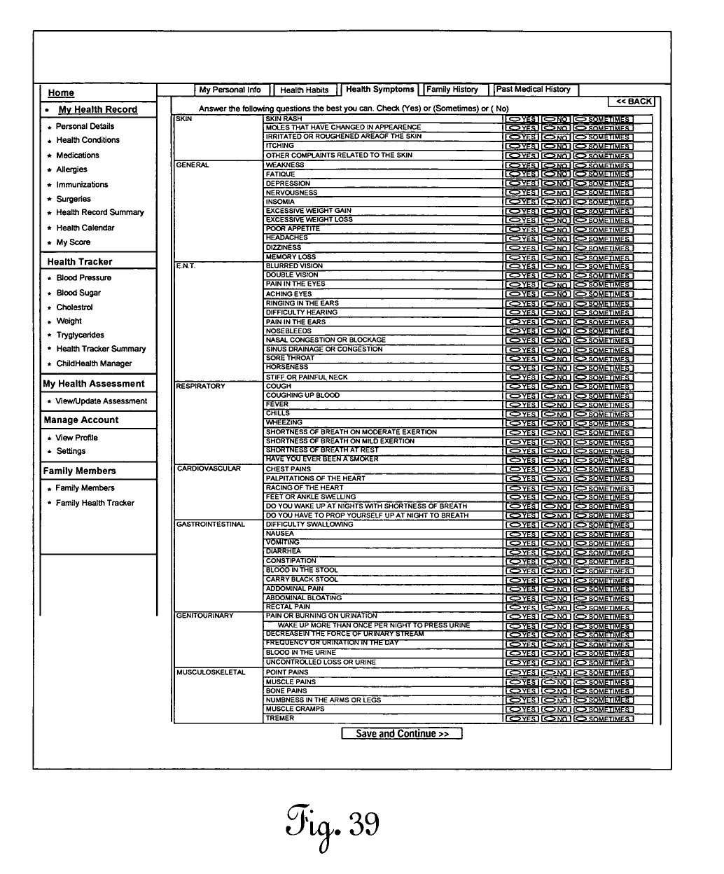

For any Online Health Management System to be effective, information regarding past and present medical history and condition needs to be shared with the health care providers through the Online Health Management System. As shown in FIG. 38 and FIG. 39, respectively, the healthwatcher or other family member can add the information requested about past medical history and current clinical symptoms. Such information is vital for a health care provider to diagnose and treatment clinical problems.

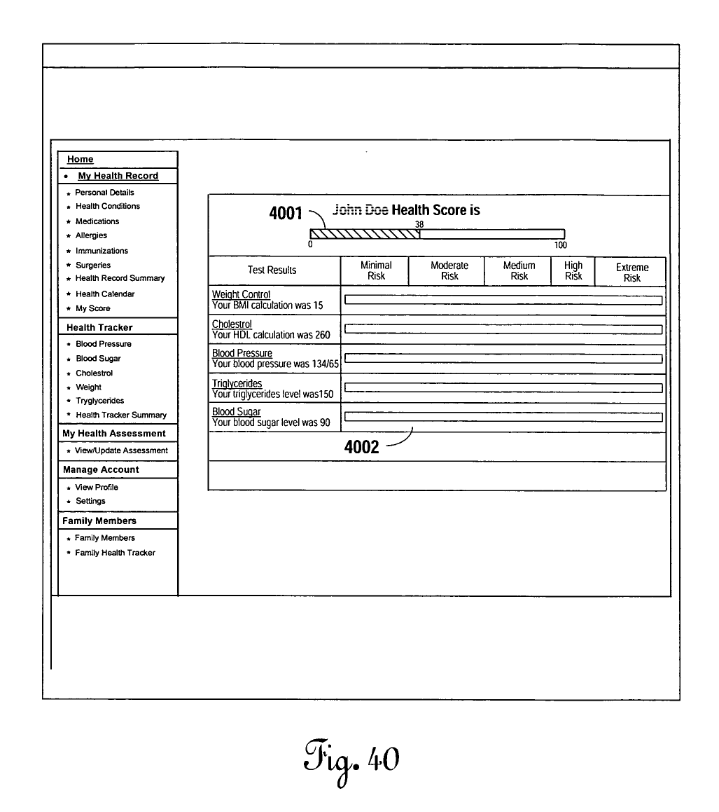

As mentioned above, the Online Health Management System disclosed herein assists in the maintenance of good health, in part, by recording and analyzing certain vital signs such as blood pressure, blood sugar, body mass index, cholesterol and triglycerides. It is estimated that analysis of abnormalities in the aforementioned vital signs and the clinical conditions associated with those abnormalities account for about 80% of the chronic disease encountered in the United States. Those diseases include diabetes and cardiovascular diseases including stroke. The Online Health Management System discloses herein provides an easy and convenient way to monitor those vital signs as demonstrated in FIGS. 40, 41, 42, 43, 44, 45, 46, 47, 48, 49, 50, 51, 52, 53, 54 and 55.

As described above the Online Health Management System disclosed herein tracks certain vital signs and compares the results obtained through the measurement of those vital signs with known published standards of normal values for each of the different vital signs. A value is assigned to each vital sign based on the extent to which it differs from the published standard for that vital sign. All of the assigned values for all of the vital signs are averaged together and a health score is developed. The health score is a two digit number on a scale between 1 and 100 with 100 representing an extreme risk for disease development and 1 representing minimal risk of disease development. A hypothetical health score 4001 is demonstrated in FIG. 40. The information regarding each vital sign is displayed in such a manner that the healthwatcher can readily determine which, if any, of the vital signs 4002 represent minimal, moderate, medium, high or extreme risk of disease development. Based on the information provided the healthwatcher or family member is armed with the information to take positive steps to improve health.

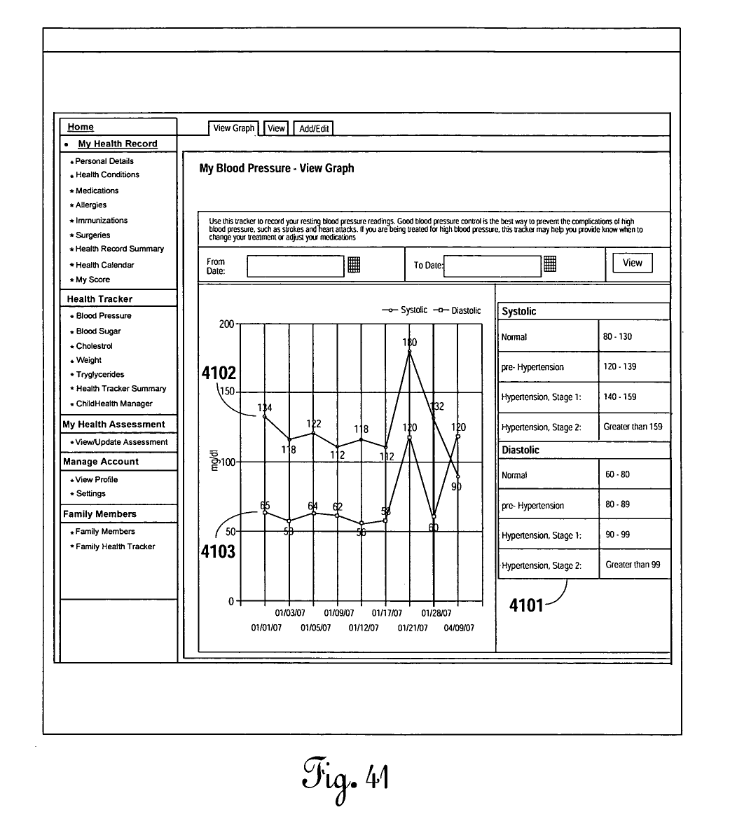

FIG. 41 is a demonstration graphically displaying blood pressure recordations over a period of time for one individual member of the family. The computer screen shows the systolic 4102 pressure separately from the diastolic 4103 pressure. Interpretive data 4101 is included to assist the healthwatcher or other family members in ascertaining the meaning of the blood pressure data and reduce the risk of disease.

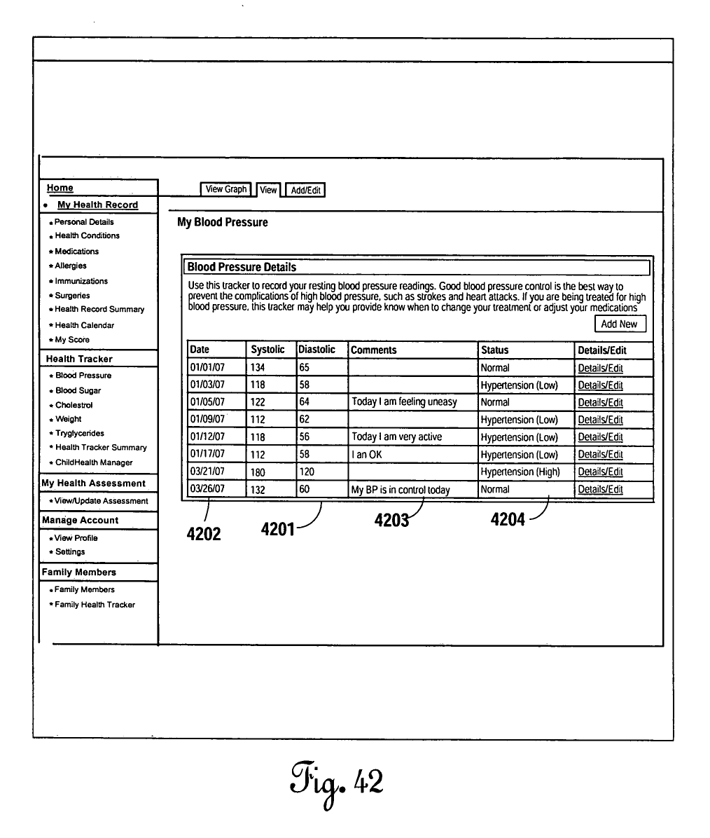

As shown in FIG. 42, the individual family members blood pressure recordations are shown in tabular form 4201 by date 4202. The interactive computer screen enables the input of subjective information about how the individual was feeling on the day the blood pressure was recorded. An interpretation of the blood pressure data as hypotensive, hypertensive or normal is provided to assist the healthwatcher interpret the meaning of the blood pressure data.

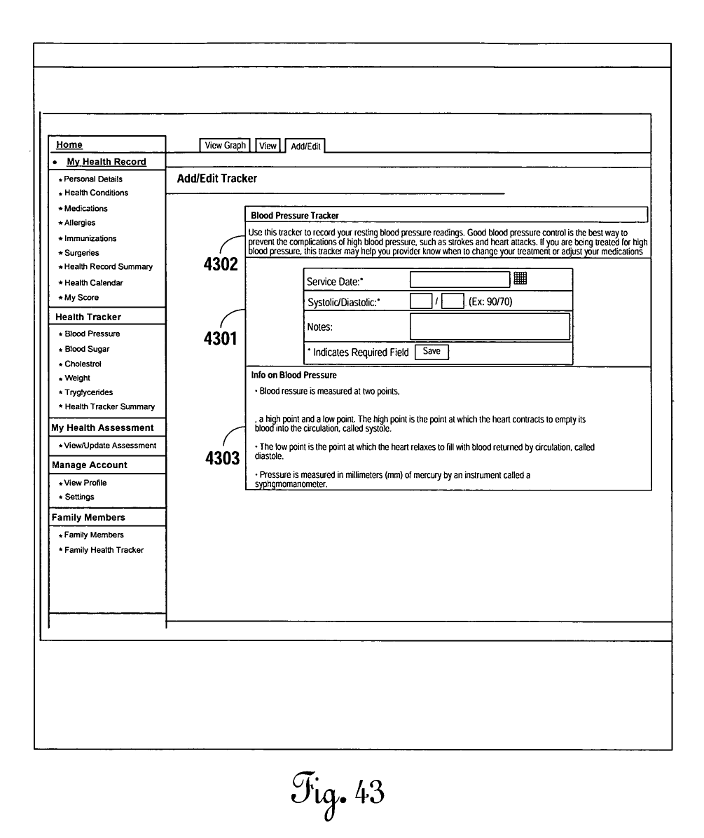

FIG. 43 demonstrates the manner in which blood pressure readings made by a health care provider may be entered into the Online Health Management System. The interactive screen provides for entry of relevant blood pressure data 4301 so that it may be stored in the Online Health Management System. Informative data regarding the importance of regular measurements of blood pressure 4302 and identification of the various components of the blood pressure reading 4303 are provided to assist the healthwatcher in interpretation of the results and provide an understanding of why such results are important.

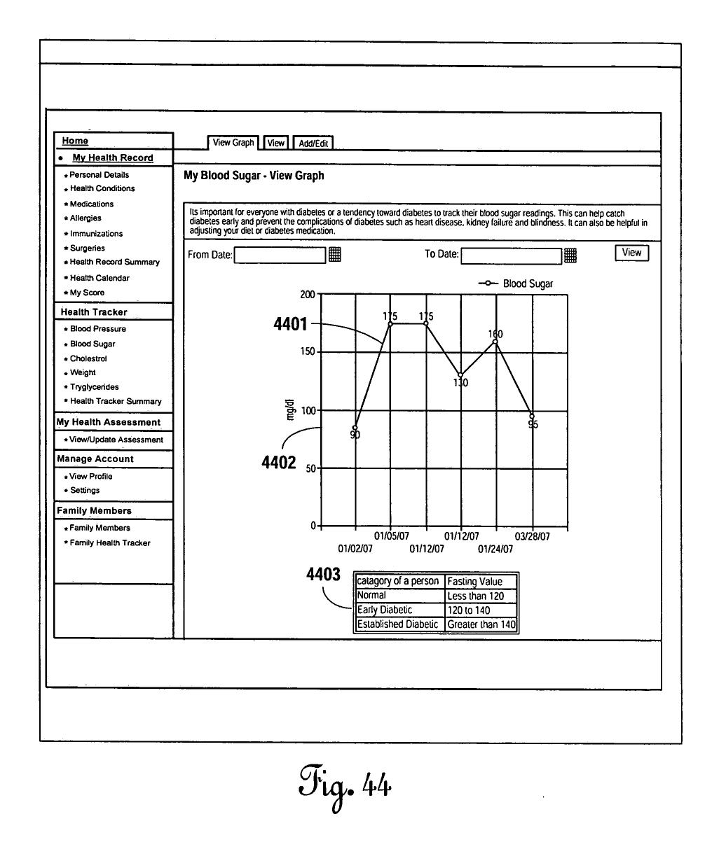

Another vital sign tracked by the Online Health Management System disclosed herein is blood sugar. Regular measurement of blood sugar is important in the diagnosis and treatment of diabetes. As shown in FIG. 44 a series of blood sugar measurements 4401 is graphically displayed over a period of time. The graph is shaded in the area in which a normal blood sugar result would be expected 4402. Examination of the graphically displayed blood sugar levels enables the healthwatcher to quickly determine if the blood sugar level on any particular day are within normal limits. Further, information 4403 regarding the meaning of specific blood pressure measurements is provided. Provision of this type of information to the healthwatcher or family member may encourage the family member to take steps to protect his health.

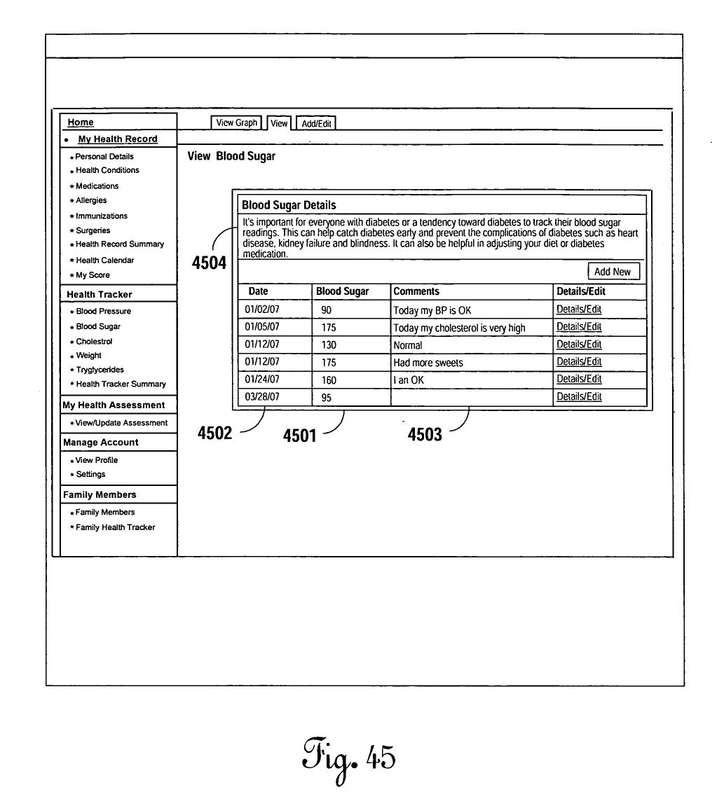

As with blood pressure, blood sugar is also displayed in tabular form as demonstrated in FIG. 45. This interactive screen displays blood sugar levels 4501 as a function of time 4502. Subjective comments are also shown 4503. Such subjective comments 4503 may enable the healthcare provider to interpret the meaning of an abnormal blood sugar level. The importance of regular blood pressure measurement is underscored 4504 so as to encourage the routine periodic measurement of blood sugar levels.

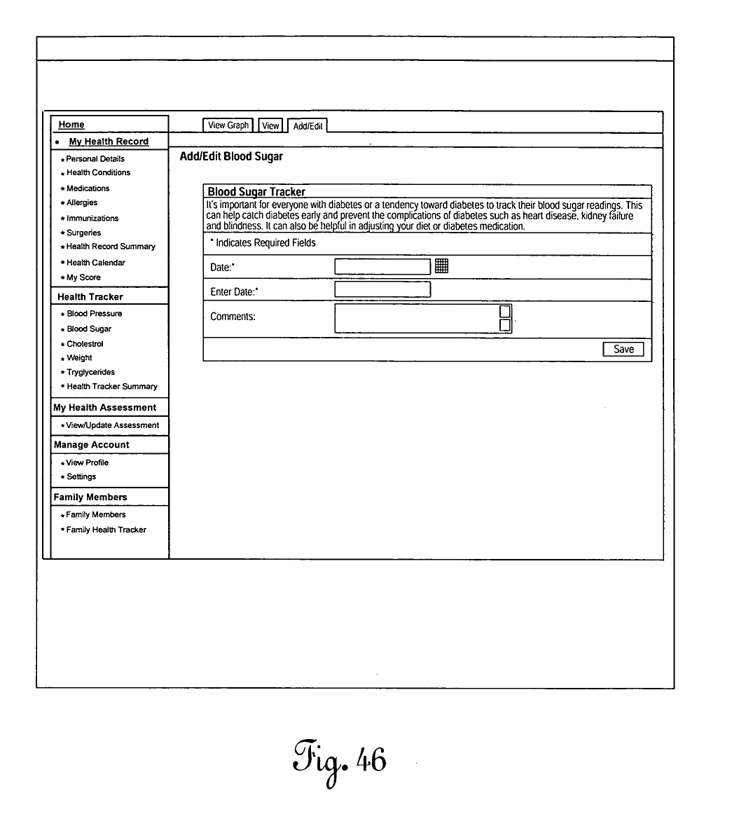

The method of entry of blood sugar levels and subjective comments is demonstrated FIG. 46. Through the interactive computer screen the blood sugar level, date measured and subjective comments are entered and stored in the Online Health Management System.

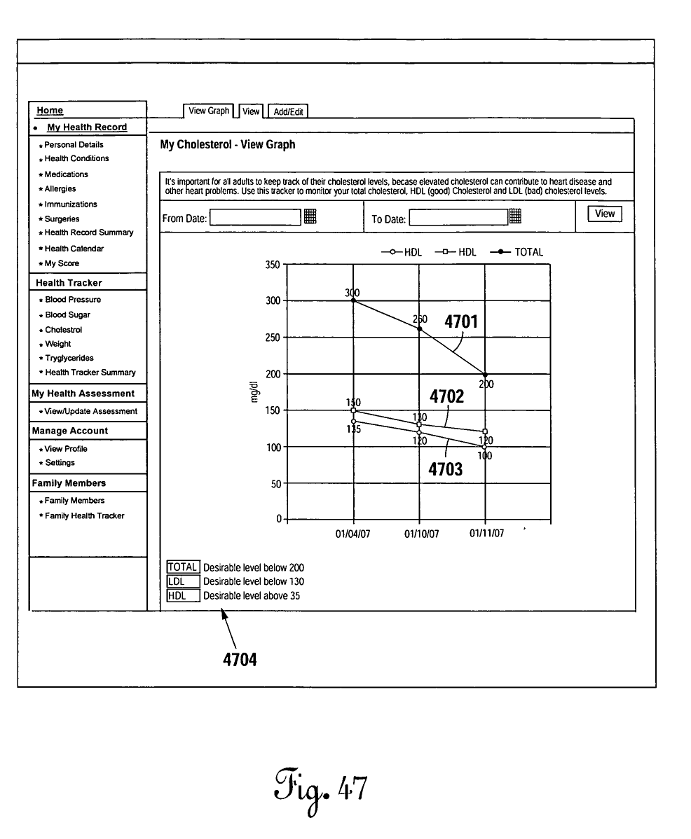

Like the other vital signs, cholesterol is tracked by the Online Health Management System disclosed herein as shown in FIG. 47. Information regarding cholesterol measurement is entered into the Online Health Management System and graphically displayed. Total cholesterol 4701 is graphically shown as a function of time as is LDL 4702 and HDL 4703. Information is provided to enable the healthwatcher interpret the meaning of the cholesterol 4701, HDL 4701 and LDL 4703 measurements 4704. Moreover, the graph is shaded to indicate where a normal cholesterol 4701, HDL 4702 or LDL 4703 result should be. The healthwatcher can determine if a family member' cholesterol 4701, HDL 4702 or LDL 4703 is outside of normal limits and encourage the family member to alter his habits to improve the cholesterol level.

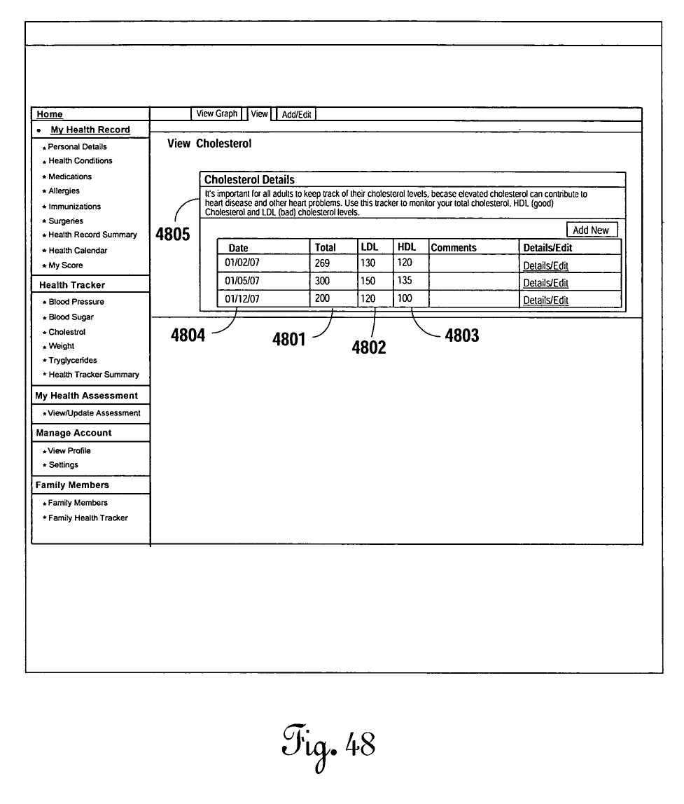

The Online Health Management System disclosed herein will also display cholesterol results as a function of time as shown in FIG. 48. The interactive screen demonstrated in FIG. 48 displays total cholesterol 4801, LDL 4802, and HDL 4803 and the date on which those values were determined 4804. The importance of monitoring cholesterol levels is reinforced 4805 so that the healthwatcher will be educated and thus, motivated to follow her family's cholesterol levels and seek appropriate intervention when necessary.

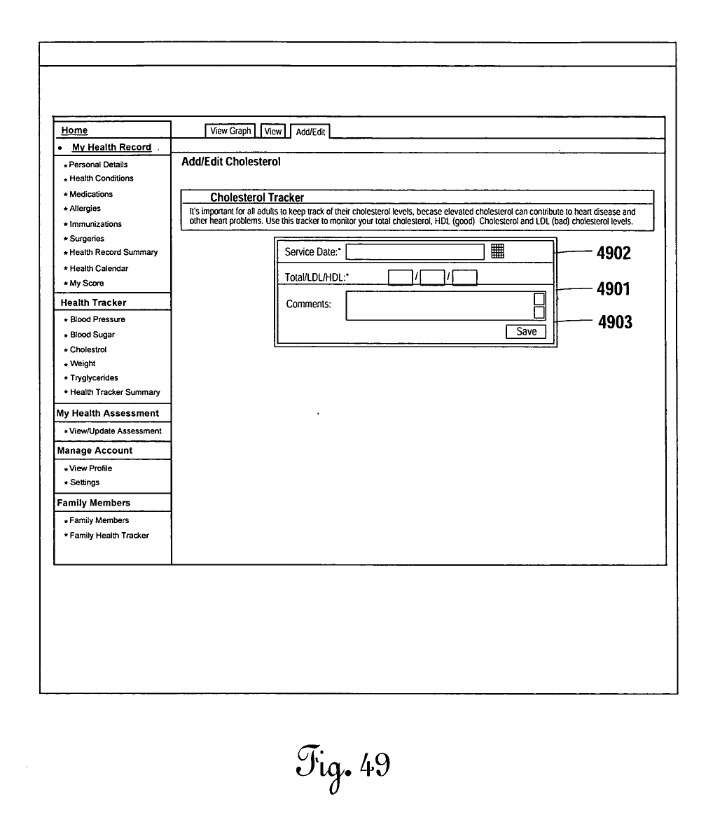

No system for health management would be complete without a mechanism for entering data regarding cholesterol measurement. The Online Health Management System disclosed herein accomplishes this feat through an interactive screen shown in FIG. 49. The health care provider or healthwatcher can enter the necessary data regarding total cholesterol, LDL and HDL 4901 and the date those compounds were measured 4902 with subjective comments 4903 for inclusion the Online Health Management System database for future review.

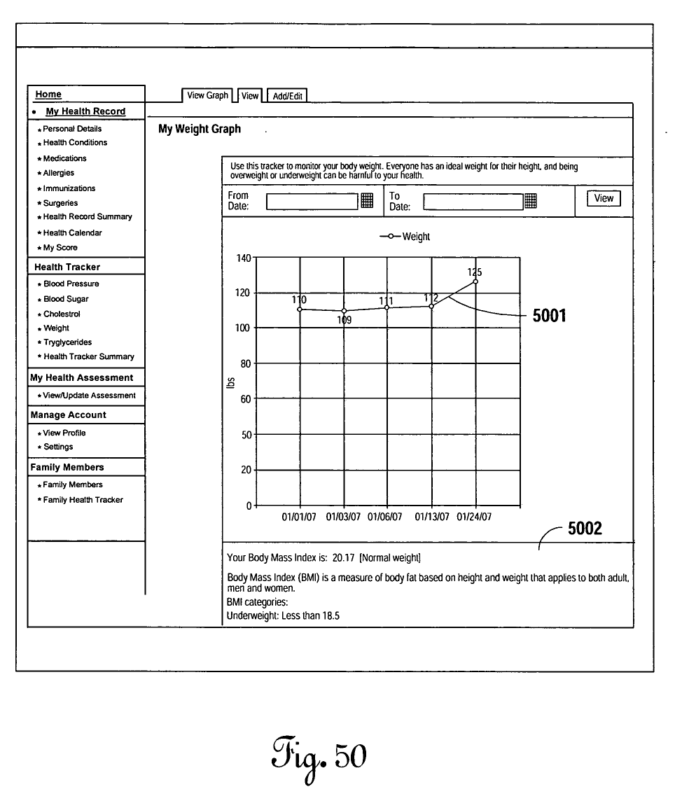

Obesity is a major factor potentially affecting the health of many people. The Online Health Management System tracks obesity by maintaining records of an individual's weight and calculating the body mass index (BMI) as shown in FIG. 50. The persons' body weight is displayed graphically 5001 and the Online Health Management System calculates the BMI from the person's height and weight and displays the BMI 5002. The Online Health Management System also advises the healthwatcher as to whether the displayed BMI is within the normal range. With this information, the healthwatcher can encourage her family members to take steps to maintain a normal body weight.

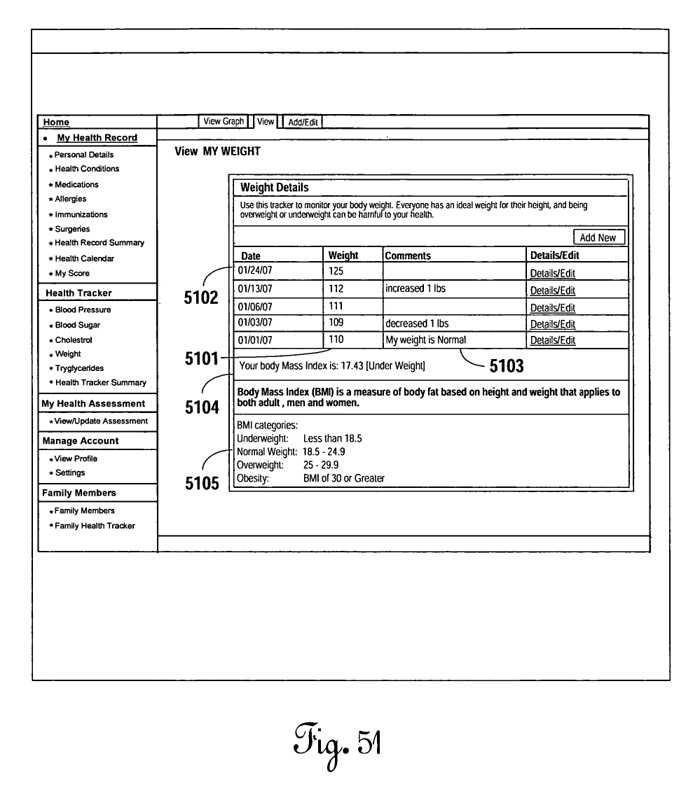

The Online Health Management System disclosed herein can also display the recorded body weight measurements in tabular form as shown in FIG. 51. The recorded weight 5101 is displayed in accordance with the date it was measured 5102. Subjective comments 5103 are displayed to explain the weight gain or loss recorded. The Online Health Management System calculates the BMI and displays the BMI on this interactive screen 5104. Data to assist the healthwatcher to interpret the meaning of the BMI is also provided 5105.

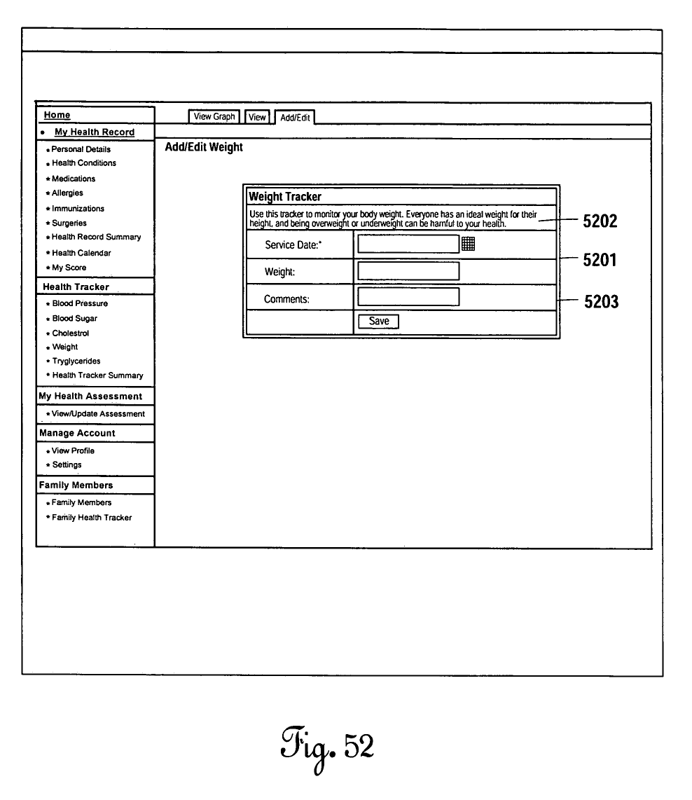

Like the other vital signs, the Online Health Management System provides an interactive screen for the recordation of weight measurements as shown in FIG. 52. The date 5201 the weight 5202 was measured is recorded in the appropriate spaces in the interactive computer screen along with any subjective comments. This data will be used to generate the data shown in FIGS. 50 and 51.

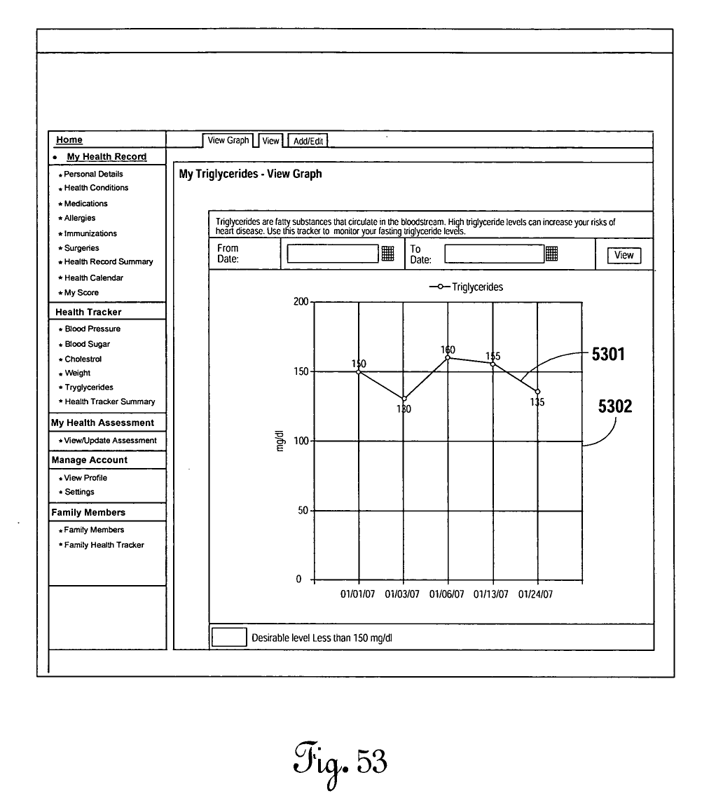

Triglycerides are fatty substances which circulate in the blood and contribute to the development of heart disease. The Online Health Management System disclosed herein maintains a record of triglyceride measurement as shown in FIG. 53. The triglyceride measurements 5301 are displayed graphically over a period of time. The graph showing the triglyceride measurements 5301 is shaded to show the healthwatcher where the normal range of triglycerides is located. With this information, the healthwatcher can readily ascertain that the triglyceride level of one of her family members is outside the normal range. Information is also provided to the healthwatcher as to the upper limit of the normal triglyceride range 5303 so that the healthwatcher can quantify the amount by which the triglyceride level is above the normal level. This number and knowledge can be used to encourage and motivate the affected individual to take steps to bring the triglyceride level within normal ranges.

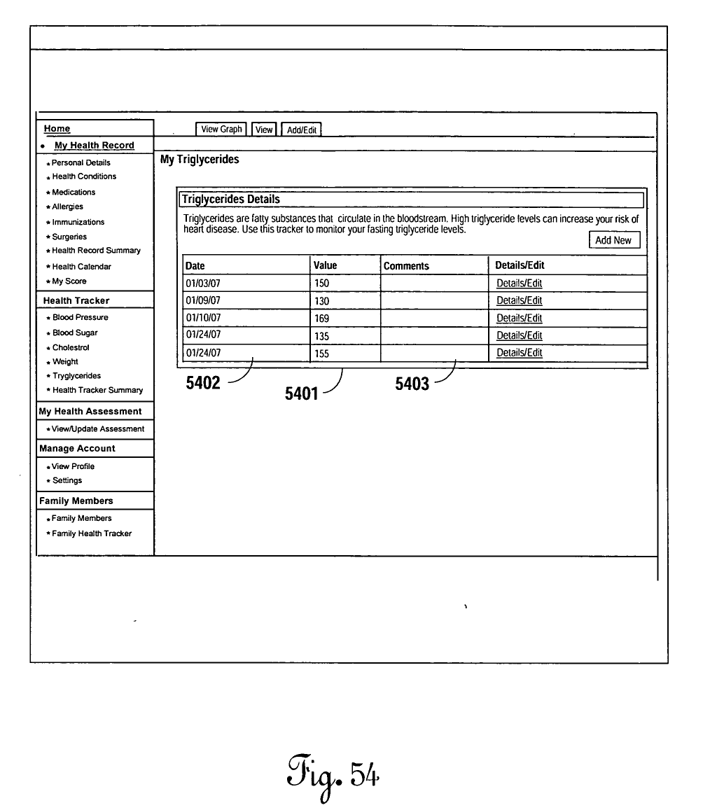

Like the other vital signs tracked by the Online Health Management System of the present invention, the triglyceride measurements may be displayed in tabular form as shown in FIG. 54. The triglyceride level 5401 is displayed in a table according to the date it was measured 5402. The interactive screen contains a space 5403 for the inclusion and of subjective comments, if any.

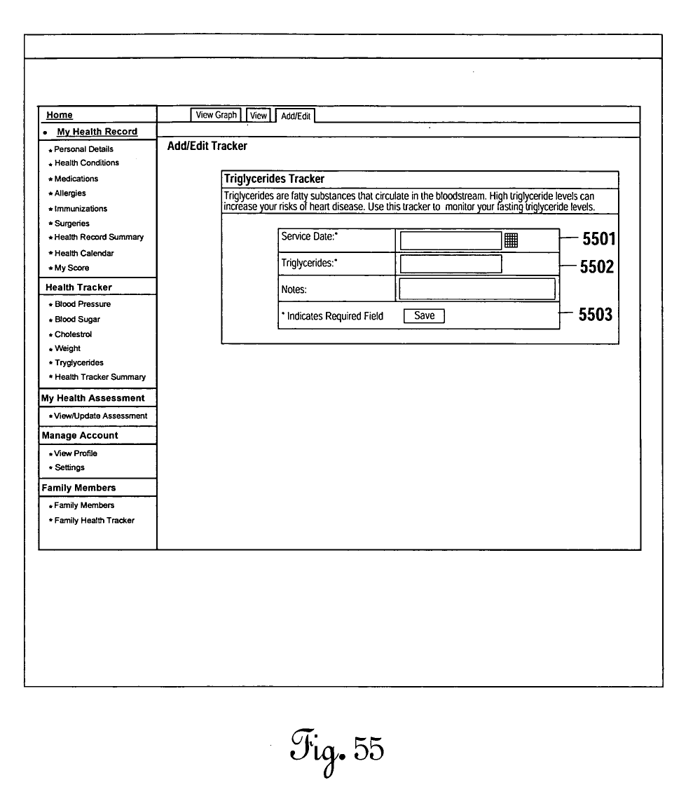

The Online Health Management System of the present invention also provides a means for recording triglyceride levels and other information as shown in FIG. 55. The date 5501 is recorded in the available space. The triglyceride level 5502 is recorded in a space on the interactive computer screen as are any subjective comments 5503. This information regarding triglyceride levels is used to develop graphs such as those shown in FIGS. 53 and 54.

As initially described above, the Online Health Management System disclosed herein enables a link between the primary care physician, the patient and the patient's family when the patient requires care outside of a health care facility. Care such as home health care, in which nurses or other health care professionals periodically visit the home of the patient and perform clinical evaluations, assess the effectiveness of the treatment plan, provide health education and other items designed to promote a return to health on behalf of the patient. In many cases these home health services are provided in an environment disconnected from hospitals and physician work environments. Patients are discharged from the hospital with an order from a physician for referral to a home health service which will provide the home health nursing required by the patient. The home health service providers evaluate, admit and provide services with verbal orders from the patient's physician supported by paper documentation.

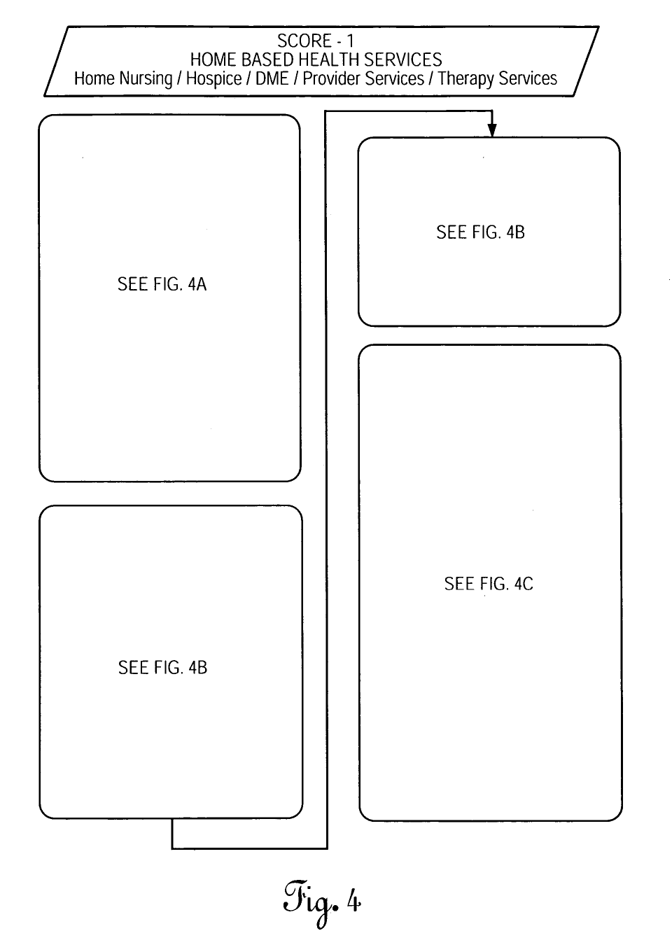

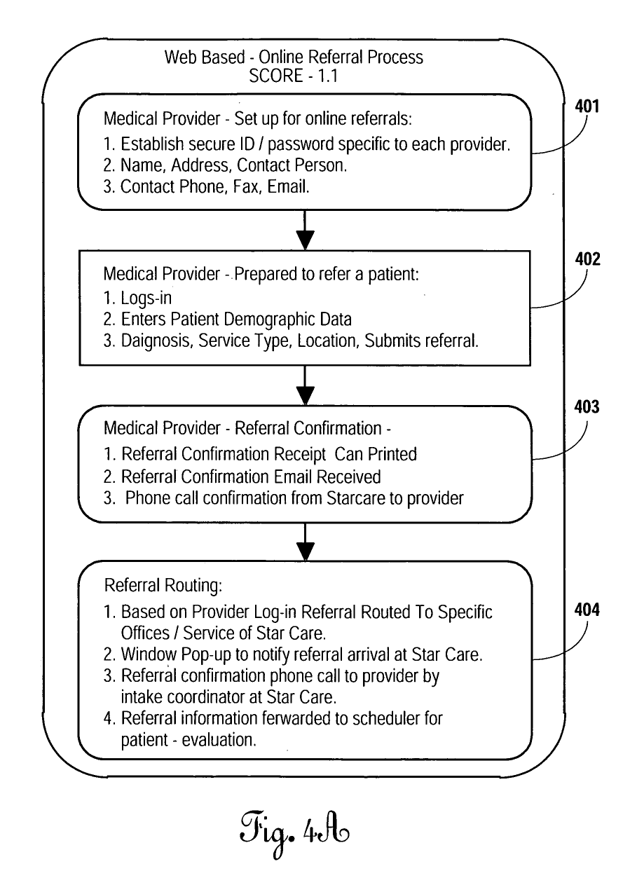

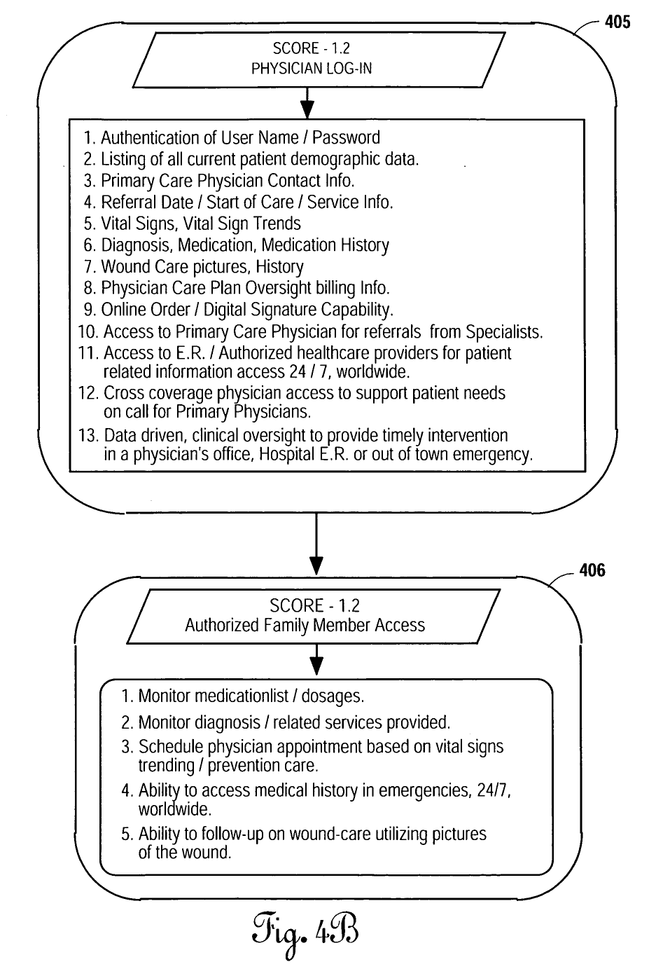

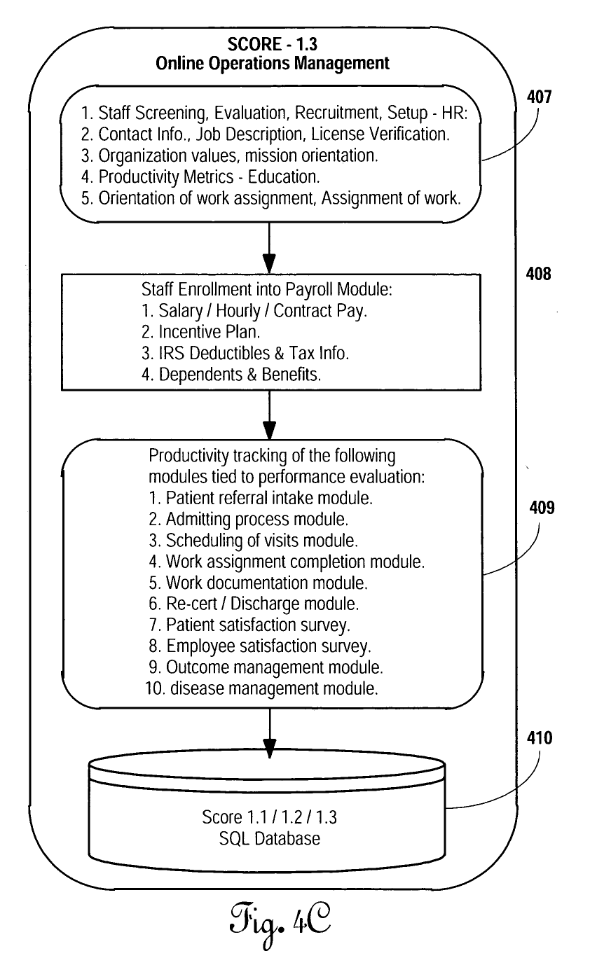

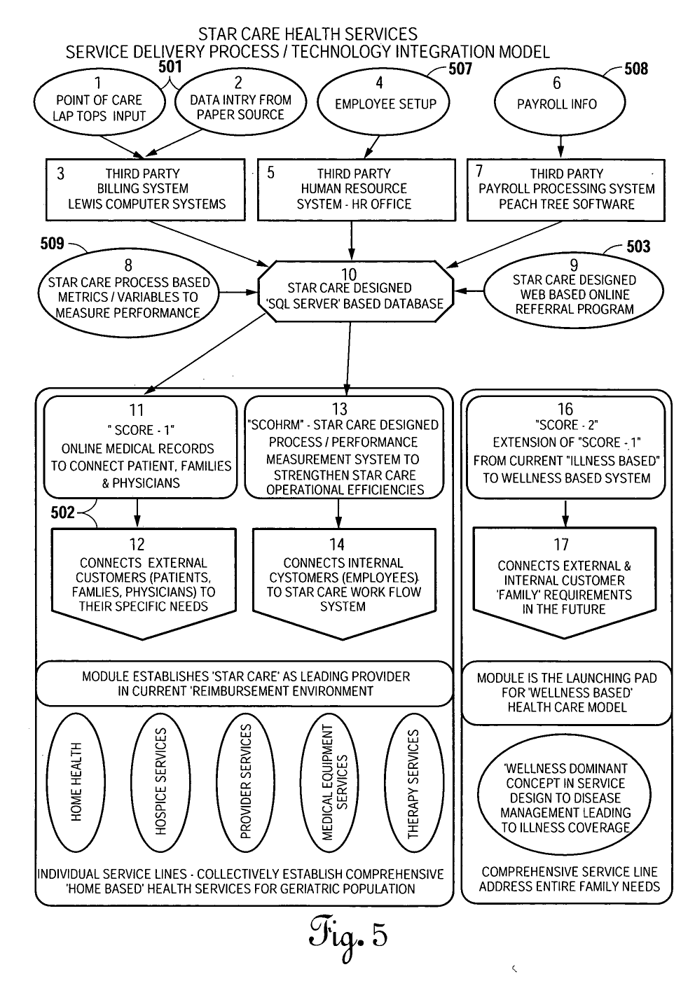

The process flow of the Online Health Management System described herein relating to linking home health services with the physician and the patients family is shown in FIGS. 4, 4A, 4B and 4C and 5. The process is initiated when a physician orders home health services in a hospital for a patient who no longer needs hospital services and is ready to be discharged from the hospital or from the physician's office when the doctor is evaluating a patient who is deemed to require home health services. Presently there is no reliable method or confirmation of when, where and how the referral order has been completed. There is no accountability when the home health service provider received the referral order or when the patient was evaluated and if the patient was actually admitted to the home health service or not. If the patient was admitted to the home health service there is no accountability as to what services are being provided. The Online Health Management System solves these problems by establishing a system for the medical provider to make online referrals for home health referrals by establishing a method in which the online database has all the information centralized in one place. A secure user name and password are issued to each medical provider. Multiple physicians in an office can have individual log-in privileges or access to the system can be office-based to allow all medical providers in the office to access the system 401 501. When the medical provider is ready to refer a patient for home health services, the Online Health Management System web site is access and the medical provider can log in to the web site using the specific user name and password. The medical provider enters the patients demographic data, diagnosis of the patients problem, type of service requested and location in which the service is to be provided 402, 502. After the request for home health services is submitted the medical provider receives a confirmation of the referral 403, 503. The referral confirmation can be printed for storage in the patient's paper medical record or recorded digitally in the patient's digital file. Referral for home health services can be made to be delivered at a location anywhere in the United States.

When the referral for home health services is received by the Online Health Management System, a provider near the location where the services are to be rendered is contacted. The intake team which is part of the Online Health Management System confirms with the provider that a referral has been received and the patient is scheduled for evaluation by the intake coordinator 404, 504. The ordering physician is advised by email of the referral. This Online Health Management System prevents a patient who is to receive home health services from being overlooked and not evaluated by the home health service as ordered by the physician. The physician receives confirmation that his/her order for referral to home health services has been received and acted upon. The patient receives the home health care needed.

Once the home health referral has been made, the home health service provider will generate records which are stored in the Online Health Management System. These records may be reviewed by the physician who ordered the referral to home health services by simply logging in to the database 405, 505. Likewise, the home health service provider can access the online medical record database in ordering to confirm physician orders, verify medications and dosages, assess vital sign trends and enter digital photographs of various stages of wound healing or the appearance of a new rash, for example. In this fashion all participants in the care of the patient can be knowledgeable about the totality of care provided to the patient. Moreover, if the patient has an emergency or has to be readmitted to the hospital, the medical information stored in the Online Health Management System database is available for review by the new health providers.

In a setting in which home health is being provided to a patient, family members located far from the patient can stay involved and aware of the treatment and condition of the patient through access to the medical record stored in the database of the Online Health Management System 406, 506. From anywhere in the world in which there is a computer link to online services, a family member can follow the care provided to another family member. The distant family member can monitor medications, diagnosis and treatment plans, scheduled physician appointments and the progress of wound healing utilizing pictures of the wound entered into the database. These data are available in an emergency, anytime, anyplace. The system described herein enables family members to stay involved in the care of other family members from any location in the world.

The Online Health Management System described herein also promotes the effective delivery of home health services by assisting the home health provider with an online operations management program. The Online Health Management System can provide human resources functions and assist with recruitment, screening, evaluation, license verification of new and existing employees. Information such as nurse licensure is readily available through online access and a prospective employee's license could be verified easily 407, 507. Employees can be assigned to patients and productivity measured by the Online Health Management System. The number of patients seen be each provider, how long was spent with each patient and the acuity of the patient could be tracked to establish productivity metrics for the home health service. In this way productivity standards could by implemented, increasing the efficiency of the home health service 409′ 509. Since the Online Health Management System tracks employee productivity, it can also track employee payroll and tax payments 408, 508.

The aforementioned described embodiment uses home health services as an example and not a limitation. Other health services such as hospice service, medical equipment service, therapy services and other health provider services could be incorporated into the Online Health Management System. The specification set forth above discloses other embodiments of the invention not specifically disclosed. Those other embodiments are included as if specifically described in the specification and are within the limes of the claims set forth herein.

I claim:

1. A method of online health management comprising the steps of:
providing secure access into an online database;
entering an individual's demographic information, past medical history and current medical condition into said online database;
entering an individual's vital signs into said online database;
storing said vital signs in said online database;
comparing said vital signs with published standards of normality;
assigning a health score based on the relationship of said vital signs with said published standards of normality;
communicating said health score to said individual so that said health score is used to assess said individual's relative risk of disease development and measure the effectiveness of a treatment plan.

2. The method of online health management as defined in claim 1 wherein said individual's vital signs are selected from a group including: blood pressure measurement, blood sugar level determination, calculation of body mass index, measurement of triglycerides and measurement of cholesterol.

3. The method of online health management as defined in claim 1 wherein said individual's demographic information includes: name, address, telephone number, email address, next of kin, identity of health insurance provider, employer and level of education.

4. The method of online health management as defined in claim 1 wherein said individual's past medical history includes: height, weight, birth date, smoking habits, alcohol consumption, allergies, previous illnesses, previous surgeries, vaccinations, injuries, illicit drug use and parent's medical history.

5. The method of online health management as defined in claim 1 wherein said individual's current medical condition includes: current treatment by a health care provider, current physical complaints and current clinical signs and symptoms.

6. A method of online health management comprising the steps of:
providing secure access into an online database;
entering a family's demographic information, past medical history and current medical condition into said online database;
entering a family's vital signs into said online database;
storing said vital signs in said online database;
comparing said vital signs with published standards of normality;
assigning a health score based on the relationship of said vital signs with said published standards of normality;
communicating said health scores to said family so that said health score is used to assess a family individual's relative risk of disease development and to measure the effectiveness of a treatment plan.

7. The method of online health management as defined in claim 6 wherein said family's vital signs are selected from a group including: blood pressure measurement, blood sugar level determination, calculation of body mass index, measurement of triglycerides and measurement of cholesterol levels.

8. The method of online health management as defined in claim 6 wherein said family's demographic information includes: name, address, telephone number, email address, next of kin, name of employer, name of health insurance provider and educational background.

9. The method of online health management as defined in claim 6 wherein said family's past medical history includes: height, weight, previous illnesses, previous surgeries, vaccinations, allergies and previous foreign travel.

10. The method of online health management as defined in claim 6 wherein said family's current medical condition includes current medications, current medical treatment, current health care providers, current physical complaints and current clinical signs and symptoms.

11. A method of online health management comprising the steps of:
identifying an individual's potential health care payment sources;
analyzing said individual's schedule of health care payment benefits provided by said health care payment sources;
listing temporally said individual's said available schedule of health care payment benefits;
communicating electronically said health care payment benefits to said individual so that said health care payment benefits may be used to promote the maintenance of health rather than for treatment of medical problems only.

12. The method of online health management as defined in claim 11 wherein said potential health care payment sources include employer funded health insurance.

13. The method of online health management as defined in claim 11 wherein said potential health care payment sources include private health insurance.

14. The method of online health management as defined in claim 11 wherein said potential health care payment sources include a government-funded insurance program.

15. The method of online health management as defined in claim 11 wherein said potential health care payment sources include uninsured payment programs.

16. A method of online health management comprising the steps of:
analyzing a family's available health care payment sources;
listing said family's said available health care payment sources;
itemizing benefits provided to the family by the said available health care payment sources;
communicating said benefits to said family so that said benefits can be used by the family to promote health rather than obtain treatment of medical problems only;

17. The method of online health management as defined in claim 16 wherein said available health care payment sources include an employer funded health insurance plan.

18. The method of online health management as defined in claim 16 wherein said available health care payment sources include private health insurance.

19. The method of online health management as defined in claim 16 wherein said available health care payment sources include government funded health insurance programs.

20. The method of online health management as defined in claim 16 wherein said available health care payment sources include uninsured health payment sources.

21. A method of online health management which notifies parents as to when a child's vaccinations are required comprising the steps of:
entering vaccination recommendations of physician groups and government agencies into an online database;
providing secure access to said online database;
entering a birthdate of said child into said database;
comparing the age of said child with the age at which vaccinations should be administered to said child as recommended by said physician groups and said governmental agencies;
determining the age of the child at which vaccinations should be administered;
communicating to the parent of the child the date on which vaccinations should be administered so that the child may receive the recommended vaccinations at a time recommended;
recording into the database when a vaccination has been administered to the child.

22. A method of Online Health Management linking by computer, the family, the family's healthcare providers and the family's health insurance providers comprising the steps of:
providing secure access to an online database;
entering medical records from any health care provider into said online database;
allowing review of said medical records by the family, by the health care providers, or by the family is health insurance providers;
permitting continuous access to said medical records from anywhere in the world to allow review of said medical records in the case of an emergency.

23. A method of Online Health Management for referral of a patient to outpatient health services comprising the steps of:
providing secure access to an online database:
receiving referrals from physicians for outpatient health services to be provided to the patient;
sending confirmation of said referrals from physicians for outpatient services to said physicians;
identifying an appropriate outpatient service provider;
engaging said identified outpatient service provider to provide said outpatient health services as ordered by said physician;
providing said identified outpatient service provider with said physician's orders;
scheduling an appointment for the patient with said identified outpatient service provider;
confirming said scheduled appointment with said identified outpatient service provider;
notifying said physician of said scheduled appointment;
confirming that said outpatient health service was provided to the patient.

24. The method of online health management as defined in claim 23 wherein said outpatient health services are selected from a group including: home health services, intravenous therapy service, diagnostic radiology, therapeutic radiology, mental and psychiatric services, ambulatory or day surgery or laboratory services.

25. A method of online health management of human resources functionsfor an outpatient health service provider comprising the steps of:
providing secure access to an online database;
permitting entry of data into said online database;
collecting information regarding new employees;
verifying said information regarding said new employees.

26. The method of online health management for said outpatient health service provider as defined in claim 25 wherein said information regarding new employees is selected from a group including: licensure, previous employment, education, criminal record, professional liability insurance, drug testing, letters of reference, and personal demographic data.

27. A method of online health management for an outpatient health service provider's payroll functions comprising the steps of:
providing secure entry into an online database;
tracking hours worked for each employee;
calculating an employee's pay based on said hours worked;
communicating said pay information to said online database of the outpatient health service provider.

28. A method for tracking productivity of an outpatient health service provider's employees comprising the steps of:
providing secure entry into an online database;
tracking hours worked by each employee;
counting number of patients attended to by each employee;
determining clinical acuity of each patient seen by each employee;
factoring the clinical acuity of each patient with the number of patients seen by each employee;
calculating productivity of each employee based on number of patients seen and acuity of the patients seen.

29. A method of online health management in which a patient is notified of events comprising the steps of:
providing secure entry of said events into an online database;
organizing said events into a calendar in said online database;
alerting the patient of one or more events at a predetermined time.

30. The method of online health management in which the patient is notified of events as defined in claim 29 wherein:
said entry is selected from a group including: doctor's appointments, ancillary health appointments, gym appointments and times to take a medicine.

31. The method of online health management in which the patient is notified of events as defined in claim 29 wherein:
said alert is selected from a group including: a telephone call, an email, a text message and a voice mail.

32. A system of online health management comprising:
means for providing secure access into an online database;
means for entering an individual's demographic information, past medical history and current medical condition into said online database;
means for entering an individual's vital signs into said online database;
means for storing an individual's vital signs in said online database;
means for comparing said vital signs with published standards of normality;
means for assigning a health score based on the relationship of said vital signs with said published standards of normality;
means for communicating said health score to said individual so that said health score is used to assess an individual's relative risk of disease development and to measure effectiveness of a treatment plan.

33. The system of online health management as defined in claim 32 wherein:
said vital signs are selected from a group including: blood pressure measurement, blood sugar level determination, calculation of body mass index, measurement of triglycerides and measurement of cholesterol.

34. The system of online health management as defined in claim 32 wherein:
said demographic information includes: comprised of name, address, telephone number, email address, next of kin, identity of health insurance provider, employer and level of education.

35. The system of online health management as defined in claim 32 in which said past medical history includes height, weight, birth date, smoking habits, alcohol consumption, allergies, previous illnesses, previous surgeries, vaccinations, injuries, illicit drug use and parent's medical history.

36. The system of online health management as defined in claim 32 wherein said current medical condition includes: current medications, current treatment by a health care provider, current physical complaints and current clinical signs and symptoms.

37. A system of online health management comprising:
means for providing secure access into an online database;
means for entering a family's demographic information, medical history and current medical condition into said online database;
means for entering a family's vital signs into said online database;
means for storing said family's vital signs in said online database;
means for comparing said family's vital signs with published standards of normality;
assigning a health score based on the relationship of said family's vital signs with said published standards of normality;
communicating said health scores to said family so that said health score is used to assess a family's relative risk of disease development and to measure effectiveness of a treatment plan.

38. The system of online health management as defined in claim 37 wherein said family's vital signs are selected from a group including: blood pressure measurement, blood sugar level determination, calculation of body mass index, measurement of triglycerides and measurement of cholesterol levels.

39. The system of online health management as defined in claim 37 wherein said family's demographic information includes: name, address, telephone number, email address, next of kin, name of employer, name of health insurance provider and educational background.

40. The system of online health management as defined in claim 37 wherein said family's past medical history includes: height, weight, previous illnesses, previous surgeries, vaccinations, allergies and previous foreign travel.

41. The system of online health management as defined in claim 37 wherein said family's current medical condition comprises current medications, current medical treatment, current health care providers, current physical complaints and current clinical signs and symptoms.

42. A system of online health management comprising:
means for identifying an individual's potential health care payment sources;
means for analyzing an individual's available schedule of health care payment benefits provided by said individual's health care payment sources;
means for listing temporally said individual's said available schedule of health care payment benefits;
means for communicating electronically said available schedule of health care payment benefits to said individual so that said health care payment benefits may be used to promote maintenance of health rather than for treatment of medical problems only.

43. The system of online health management defined in claim 42 wherein said individual's health care payment sources include employer funded health insurance.

44. The system of online health management as defined in claim 42 wherein said health care payment sources include private health insurance.

45. The system of online health management defined in claim as 36 wherein said health care payment sources includes a government-funded insurance program

46. The system of online health management as defined in claim 42 wherein said health care payment sources includes uninsured payment programs.

47. A system of online health management comprising:
means for analyzing a family's available health care payment sources;
means for listing said family's available health care payment sources;
means for itemizing benefits provided to a family from said available health care payment sources;
means for communicating said benefits to said family so that said benefits can be used by the family to promote health rather than obtain treatment of medical problems only;

48. The system of online health management as defined in claim 47 wherein said health care payment source includes an employer funded health insurance plan.

49. The system of online health management as defined in claim 47 wherein said health care payment source includes private health insurance.

50. The system of online health management as defined in claim 47 wherein said health care payment sources includes government funded health insurance programs.

51. The system of online health management as defined in claim 47 wherein said health care payment sources includes uninsured health payment sources.

52. A system of online health management which notifies parents as to when a child's vaccinations are required comprising:
means for entering vaccination recommendations of physician groups and government agencies into an online database;
means for providing secure access to said online database;
means for entering a birthdate of a child into said database;
means for comparing the age of said child with recommended age at which vaccinations should be administered to said child;
means for determining the age of the child at which vaccinations should be administered;
means for communicating to the parent of said child a date that vaccinations should be administered so that the child may receive the recommended vaccinations at a time required;
means for recording into the online database that said vaccination has been administered to the child.

53. A system of Online Health Management linking by computer, a family, a family's healthcare providers and a family's health insurance providers comprising:
means for providing secure access to an online database;
means for entering medical records from any health care provider into said online database;
means for allowing review of said medical records by the family, the health care providers, or the family health insurance providers;
means for permitting continuous access to said medical records from anywhere in the world to allow review of said medical records in the case of emergency.

54. A system of Online Health Management for referral of a patient to outpatient health services comprising:
means for providing secure access to an online database:
means for receiving referrals from physicians for outpatient health services to be provided to said patient;
means for sending confirmation of said referral for out patient health services to said physician;
means for identifying an appropriate outpatient service provider;
means for engaging said outpatient service provider to provide said outpatient health services as ordered by said physician;
means for providing said outpatient service provider with said physician's orders means for scheduling an appointment for said patient with said outpatient service provider;
means for confirming said appointment with said outpatient service provider;
means for notifying said physician of said appointment;
means for confirming that said outpatient health service was provided to said patient.

55. The system of online health management as defined in claim 54 wherein said outpatient health services are selected from a group including: home health services, intravenous therapy service, diagnostic radiology, therapeutic radiology, mental and psychiatric services, ambulatory or day surgery or laboratory services.

56. A system of online health management for an outpatient health service provider's human resources functions comprising:
means for providing secure access to an online database;
means for permitting entry of data into said online database;
means for collecting information regarding new employees;
means for verifying information regarding said new employees.

57. The system of online health management for outpatient health service providers as defined in claim 56 wherein said information is selected from a group including: licensure, previous employment, education, criminal record, professional liability insurance, drug testing, letters of reference, and personal demographic data.

58. A system of online health management for an outpatient health service provider's payroll functions comprising:
means for providing secure entry into an online database;
means for tracking hours worked for each employee;
means for calculating pay based on said hours worked;
means for communicating said pay to management of said outpatient health service provider.

59. A system for tracking productivity of an outpatient health service provider comprising:
means for providing secure entry into an online database;
means for tracking hours worked by each employee;
means for counting number of patients attended to by each said employee;
means for determining the clinical acuity of each patient seen by said employee;
means for factoring the clinical acuity of each patient with the number of patients seen;
means for calculating the productivity of each employee based on number of patients seen and acuity of the patients seen.

60. A system of online health management in which a patient is notified of events comprising:
means for providing secure entry of said events into an online database;
means for organizing said events into a calendar in the online database;
means for alerting said patient of the event at a predetermined time.

61. The system of online health management in which the patient is notified of events as defined in claim 60 wherein said entry is selected from a group including doctor's appointments, ancillary health appointments, gym appointments and one or more time to take a medicine.

62. The system of online health management in which the patient is notified of events as defined in claim 60 wherein said alert is selected from a group including:
telephone call, email, text message and voice mail.
